(19) United States
(12) Patent Application Publication
(10) Pub. No.: US 2006/0217819 A1
(43) Pub. Date: Sep. 28, 2006

(54) Low-pass adaptive/neural controller device and method with improved transient performance

(76) Inventors: Chengyu Cao, Blacksburg, VA (US); Naira Hovakimyan, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/387,067

(22) Filed: Mar. 23, 2006

Related U.S. Application Data
(60) Provisional application No. 60/664,187, filed on Mar. 23, 2005.

(51) Int. Cl. G05B 13/02

(52) U.S. Cl. 700/28

(57) ABSTRACT

A novel [symbol] ₁ adaptive/neural control architecture provides a device and method that permits fast adaptation and yields guaranteed transient response simultaneously for both the system's input and output signals, in addition to providing asymptotic tracking. The main feature of the invention is rapid adaptation with a guaranteed low frequency control signal. The ability to adapt rapidly ensures the desired transient performance for both the system's input and output signals, simultaneously, while a low-pass filter in the feedback loop attenuates the high-frequency components in the control signal.

This invention claims priority from U.S. Provisional Patent Application Ser. No. 60/664,187 filed on Mar. 23, 2005 and entitled Low-pass Adaptive/Neural Controller Design with Improved Transient Performance, which is incorporated herein by reference. The invention was made under partial support from contract numbers F49620-03-1-0443 and FA9550-05-1-0157 with the Air Force Office of Scientific Research, and also partial support by ADVANCE VT Institutional Transformation Research Seed Grant from the National Science Foundation.

### BACKGROUND OF THE INVENTION

1. Field of the Invention

The present invention generally relates to the control of systems with time-varying unknown parameters, time-varying bounded disturbances, and matched uncertain nonlinearities, and in particular to controllers designed to adapt to parameters that vary in uncertain ways.

2. Background Description

The conventional Model Reference Adaptive Controller (MRAC) was developed to control linear systems in the presence of parametric uncertainties. The development of this architecture has been facilitated by the Lyapunov stability theory that defines sufficient conditions for stable performance, but offers no means for characterizing the system's input/output performance during the transient phase. System uncertainties during the transient phase have led to unpredictable and/or undesirable situations, involving control signals of high frequency or large amplitudes, large transient errors or slow convergence rate of tracking errors, to name a few. Application of adaptive/neural controllers has therefore been largely restricted. Large deviation implies poor transient performance. It could even lead to instability, especially for neural controllers where the signals are required to be inside a compact set where approximation is conducted.

One such situation is bandwidth limitation in the control channel, especially in mechanical actuators. A high frequency control signal is impractical as it can lead to destabilization of the system. Another circumstance where use of conventional adaptive/neural controllers is limited is where the system models are mostly based on low-frequency approximations. A high frequency control signal can easily excite the omitted high frequency dynamics of the system and lead to unpredictable consequences.

The transient performance of adaptive/neural controllers depends on unknown parameters, reference input, and adaptive gain in a nonlinear way. Extensive tuning of adaptive gains and Monte-Carlo runs have been the primary methods for enabling the transition of adaptive control solutions to real world applications. This approach has rendered verification and validation of adaptive controllers overly challenging. Moreover, there is no systematic way of selecting design parameters that would yield the desired transient performance for all possible scenarios.

As compared to the linear systems theory, several important aspects of transient performance analysis seem to be missing in the prior art. First, all the bounds in the prior art are computed for tracking errors only, and not for control signals. Although the latter can be deduced from the former, it is straightforward to verify that the ability to adjust the former may not extend to the latter in the case of nonlinear control laws. Second, since the purpose of adaptive control is to ensure stable performance in the presence of modeling uncertainties, one needs to ensure that the changes in reference input and unknown parameters due to possible faults or unexpected uncertainties do not lead to unacceptable transient deviations or oscillatory control signals, implying that a retuning of adaptive parameters is required. Finally, one needs to ensure that whatever modifications or solutions are suggested for performance improvement of adaptive controllers, they are not achieved via high-gain feedback.

### SUMMARY OF THE INVENTION

It is therefore an object of the present invention to provide an adaptive/neural controller design with improved transient performance.

Another object of the invention is to provide a systematic way of selecting design parameters that would yield desired transient performance for all possible scenarios.

A further object of the invention is to make it easier to verify and validate adaptive controllers.

We invented a novel [symbol] ₁ adaptive/neural control architecture that permits fast adaptation and yields guaranteed transient response simultaneously for both the system's input and output signals, in addition to providing asymptotic tracking. The main feature of the invention is rapid adaptation with a guaranteed low frequency control signal. The ability to adapt rapidly ensures the desired transient performance for both the system's input and output signals, simultaneously, while a low-pass filter in the feedback loop attenuates the high-frequency components in the control signal.

The [symbol] ₁ adaptive/neural controller can be applied to systems that have time-varying unknown parameters with an arbitrary rate of variation, and also ensures the desired transient performance for both input and output signals of the system. We prove that by increasing the adaptation gain one can achieve arbitrarily close transient and asymptotic tracking for both input and output signals simultaneously.

No matter how configured, in a high-gain feedback controller or MRAC large gain or adaptive gain leads to reduced phase or time-delay margins. We demonstrate that increasing the adaptative gain will not hurt the time-delay margin of the closed-loop system with the [symbol] ₁ adaptive control architecture, in contrast to conventional adaptive or feedback schemes.

An aspect of the invention is A low-pass adaptive/neural controller for a dynamic system, comprising a reference input for the dynamic system, the dynamic system being described by a dynamic model subject to time-varying unknown parameters and an unknown time-varying disturbance, there being a measured output of the dynamic system. A companion model, described by the dynamic model, has adaptive estimates substituted in the dynamic model for the time-varying unknown parameters and the unknown time-varying disturbance, there being a computed output for the companion model. The system has means for generating a control signal to be applied to the dynamic system and the companion model so that the measured output tracks the reference input, the generating means having a low-pass filter to attenuate high frequency components in the control signal. In a further aspect of the invention, the low-pass filter is a stable transfer function and is applied by the generating means so that both the control signal and a difference between the measured output and the reference input achieve a target stability within a transient period.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic block diagram of a closed loop system with an [symbol] ₁ adaptive controller.

FIG. 2 is a schematic block diagram of a Linear Time Invariant (LTI) closed loop system.

FIG. 3 is a graph showing application of the [symbol] ₁ gain stability requirement for a control signal objective in an exemplar dynamical system.

FIG. 4a is a graph showing the system state vector, the companion model of the invention, and a bounded reference signal; FIG. 4b is a graph showing the time history of the control signal where a time varying disturbance signal is
Υ(t)=sin(πt).

FIG. 5a is a graph showing the system state vector, the companion model of the invention, and a bounded reference signal; FIG. 5b is a graph showing the time history of the control signal where a time varying disturbance signal is
σ(t)=cos(x₁(t))+2 sin(10t)+cos(15t).

FIG. 6a is a graph showing the system state vector, the companion model of the invention, and a bounded reference signal; FIG. 6b is a graph showing the time history of the control signal where a time varying disturbance signal is
σ(t)=cos(x₁(t))+2 sin(100t)+cos(150t).

FIG. 7 is a schematic of interconnection LTI systems.

FIGS. 8a and 8b are graphs of MRAC performance and time histories, respectively, for r=100 and Γ_{c}=0.04.

FIGS. 8c and 8d are graphs of MRAC performance and time histories, respectively, for r=100 and Γ_{c}=0.2.

FIGS. 9a and 9b are graphs of MRAC performance and time histories, respectively, for r=400 and Γ_{c}=0.04.

FIGS. 10a and 10b are graphs of MRAC performance and time histories, respectively, for r=25 and Γ_{c}=0.04.

FIG. 11 is a schematic showing a closed loop system with an [symbol] ₁ adaptive controller.

FIG. 12 is a schematic showing a closed loop reference LTI system.

FIGS. 13a and 13b are graphs showing the equivalent results of cascading low-pass and high-pass systems.

FIGS. 14a and 14b are graphs showing application of the [symbol] ₁ gain stability requirement for differing adaptive gain values.

FIGS. 15a and 15b are graphs showing simulation results and time histories, respectively, for an [symbol] ₁ adaptive controller.

FIGS. 16a and 16b are graphs showing performance and time history, respectively, for an [symbol] ₁ adaptive controller.

FIGS. 17a and 17b are graphs showing performance results and time histories, respectively, for an [symbol] ₁ adaptive controller.

FIGS. 18a and 18b are graphs showing performance and time history, respectively, for an [symbol] ₁ adaptive controller.

### DETAILED DESCRIPTION OF A PREFERRED EMBODIMENT OF THE INVENTION

Problem Formulation

Consider the following system dynamics:
\dot{x}(t)=Aₘx(t)+b(ωu(t)+θ^{τ}(t)x(t)+σ(t)),
y(t)=c^{τ}x(t), x(0)=x₀, Eq.1
where xεIRⁿ is the system state vector (measurable), uεIR is the control signal, yεIR is the regulated output, b,cεIRⁿ are known constant vectors, Aₘ is a known n×n matrix, ωεIR is known, θ(t)εIRⁿ is a vector of time-varying unknown parameters, while σ(t)εIR is a time-varying disturbance. Without loss of generality, we assume that
θ(t)εΘ, |σ(t)≦Δ, t≧0, Eq.2
where Θ is a known compact set and ΔεIR⁺ is a known (conservative) [symbol] _{∞} bound of σ(t).

The control objective is to design a full-state feedback adaptive controller to ensure that y(t) tracks a given bounded reference signal r(t) both in transient and steady state, while all other error signals remain bounded.

We further assume that θ(t) and σ(t) are continuously differentiable and their derivatives are uniformly bounded:
∥\dot{θ}(t)∥₂≦d_{θ}<∞, |\dot{σ}(t)|≦d_{σ}<∞, ∀t≧0, Eq.3
where

∥•∥₂ denotes the 2-norm, while the numbers d_{θ}, d_{σ} can be arbitrarily large.

[symbol]

₁ Adaptive Controller

In this section, we develop a novel adaptive control architecture for the system in Eq.1 that permits complete transient characterization for both u(t) and x(t).

The elements of [symbol] ₁ adaptive controller are introduced next:

Companion Model: We consider the following companion model:
\hat{\dot{x}}(t)=Aₘ\hat{x}(t)+b(ωu(t)+\hat{θ}^{τ}(t)x(t)+\hat{σ}(t)),
ŷ(t)=c^{τ}\hat{x}(t), \hat{x}(0)=x₀, Eq.4
which has the same structure as the system in Eq.1. The only difference is that the unknown parameters
θ(t), σ(t)
are replaced by their adaptive estimates
\hat{θ}(t), \hat{σ}(t)
that are governed by the following adaptation laws.

Adaptive Laws: Adaptive estimates are given by:
\hat{\dot{θ}}(t)=Γ_{θ}Proj(−x(t)\tilde{x}^{τ}(t)Pb,\hat{θ}(t)),\hat{θ}(0)=\hat{θ}₀ Eq.5
\hat{\dot{σ}}(t)=Γ_{σ}Proj(−\tilde{x}^{τ}(t)Pb,\hat{σ}(t)),\hat{σ}(0)=\hat{σ}₀ Eq.6
where
\tilde{x}(t)=\hat{x}(t)−x(t)
is the error signal between the state of the system and the companion model,
Γ_{θ}=Γ_{c}I_{n×n}εIR^{n×n},Γ_{σ}=Γ_{c}
are adaptation gains with
Γ_{c}εIR⁺,
and P is the solution of the algebraic equation
Aₘ^{τ}P+PAₘ=−Q, Q>0.

Control Law: The control signal is generated by:

$$\begin{matrix}u ( s ) = C ( s ) \overline{r} ( s ) , \\ where & Eq . 7 \\ \overline{r} ( t ) = \frac{{k}_{g} r ( t ) - {\hat{θ}}^{⊤} ( t ) x ( t ) - \hat{σ} ( t )}{ω} , & Eq . 8 \\ {k}_{g} = \frac{1}{{c}^{⊤} {A}_{m}^{- 1} b} . & Eq . 9\end{matrix}$$

And where

kεIR⁺ is a feedback gain, while C(s) is any strictly proper stable transfer function with low-pass gain C(0)=1. One simple choice is

$$C ( s ) = \frac{ω k}{s + ω k} . \qquad Eq . 10$$

Stability Requirement
Further, let

$$L = {max}_{θ ( t ) ∈ Θ} {\sum }_{i = 1}^{n} \vert {θ}_{i} ( t ) \vert , \qquad Eq . 11$$

where θᵢ(t) is the i^{th} element of θ(t), Θ is the compact set defined in (2). We now state the [symbol] ₁ performance requirement that ensures stability of the entire system and desired transient performance.

[symbol] ₁-gain stability requirement: Design C(s) to ensure that
∥G(s)∥ [symbol] _{₁}L<1, Eq.12
where
G(s)=(sI−Aₘ)⁻¹b(1−C(s)).

The complete [symbol] ₁ adaptive controller consists of Eq.4, Eq.5, Eq.6 and Eq.7 subject to [symbol] ₁-gain stability requirement in Eq.12.

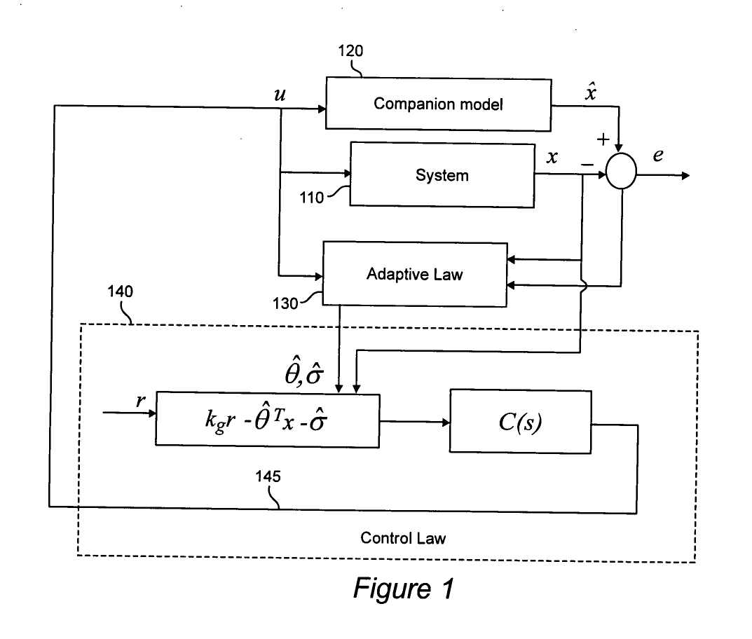

The [symbol] ₁ adaptive controller is illustrated in FIG. 1. The system to be controlled 110 is coupled with companion model 120. Companion model 120 has the same structure as system 110, but the unknown parameters are replaced by their adaptive estimates 130. Controller 140 generates a control signal u 145.

In case of constant θ(t), the stability requirement of the [symbol] ₁ adaptive controller can be simplified. For the specific choice of C(s) in Eq.10, the stability requirement of [symbol] ₁ adaptive controller is reduced to

$${A}_{g} = [ \begin{matrix}{A}_{m} + b {θ}^{⊤} & b ω \\ - k {θ}^{⊤} & - k ω\end{matrix} ] \qquad Eq . 13$$

being Hurwitz for all θεΘ.
Closed-Loop Reference System
We now consider the following closed-loop LTI reference system with its control signal and system response being defined as follows:

$$\begin{matrix}{\dot{x}}_{ref} ( t ) = {A}_{m} {x}_{ref} ( t ) + b ( ω {u}_{ref} ( t ) + {θ}^{⊤} ( t ) {x}_{ref} ( t ) + σ ( t ) ) , & Eq . 14 \\ {u}_{ref} ( s ) = C ( s ) \frac{{\overline{r}}_{ref} ( s )}{ω} , {x}_{ref} ( 0 ) = {x}_{0} , & Eq . 15 \\ {y}_{ref} ( t ) = {c}^{⊤} {x}_{ref} ( t ) , & Eq . 16\end{matrix}$$

where

\overline{r}_{ref}(s) is the Laplace transformation of the signal
\overline{r}_{ref}(t)=−θ^{τ}(t)x_{ref}(t)−σ(t)+k_{g}r(t),
And k_{g} is introduced in Eq.9.
Tracking Performance
Let
H(s)=(sI−Aₘ)⁻¹b. Eq.17
It is proved that there exists
cₒεIRⁿ
such that

$${c}_{o}^{⊤} H ( s ) = \frac{{N}_{n} ( s )}{{N}_{d} ( s )} , \qquad Eq . 18$$

where the order of N_{d}(s) is one more than the order of Nₙ(s), and both Nₙ(s) and N_{d}(s) are stable polynomials.
Theorem 1: Given the system in (1) and the [symbol] ₁ adaptive controller defined via Eq.4, Eq.5, Eq.6 and Eq.7 subject to Eq.12, we have:
∥x−x_{ref}∥ [symbol] _{_{∞}}≦γ₁, Eq.19
∥u−u_{ref}∥ [symbol] _{_{∞}}≦γ₂, Eq.20
where

$$\begin{matrix}{γ}_{1} = \frac{{‖ C ( s ) ‖}_{{ℒ}_{1}}}{1 - {‖ H ( s ) ( 1 - C ( s ) ) ‖}_{{ℒ}_{1}} L} \sqrt{\frac{{θ}_{m}}{{λ}_{max} ( P ) {Γ}_{c}}} , & Eq . 21 \\ {γ}_{2} = {‖ \frac{C ( s )}{ω} ‖}_{{ℒ}_{1}} L {γ}_{1} + {‖ \frac{C ( s )}{ω} \frac{1}{{c}_{o}^{⊤} H ( s )} {c}_{o}^{⊤} ‖}_{{ℒ}_{1}} \sqrt{\frac{{θ}_{m}}{{λ}_{max} ( P ) {Γ}_{c}}} . & Eq . 22\end{matrix}$$

Corollary 1: Given the system in Eq.1 and the [symbol] ₁ adaptive controller defined via Eq.4, Eq.5, Eq.6 and Eq.7 subject to Eq.12, we have:

$$\begin{matrix}{lim}_{{Γ}_{c} \to ∞} ( x ( t ) - {x}_{ref} ( t ) ) = 0 , ∀ t \geq 0 , & Eq . 23 \\ {lim}_{{Γ}_{c} \to ∞} ( u ( t ) - {u}_{ref} ( t ) ) = 0 , ∀ t \geq 0. & Eq . 24\end{matrix}$$

Thus, the tracking error between x(t) and x_{ref}(t), as well between u(t) and u_{ref}(t), is uniformly bounded by a constant inverse proportional to Γ_{c}. This implies that during the transient one can achieve arbitrarily close tracking performance for both signals simultaneously by increasing Γ_{c}.

Design Guidelines

We note that the control law u_{ref}(t) in the closed-loop reference system, which is used in the analysis of [symbol] _{∞} norm bounds, is not implementable since its definition involves the unknown parameters. Theorem 1 ensures that the [symbol] ₁ adaptive controller approximates u_{ref}(t) both in transient and steady state. So, it is important to understand how these bounds can be used for ensuring uniform transient response with desired specifications. We notice that the following ideal control signal

$${u}_{ideal} ( t ) = \frac{{k}_{g} r ( t ) - {θ}^{⊤} ( t ) {x}_{ref} ( t ) - σ ( t )}{ω} \qquad Eq . 25$$

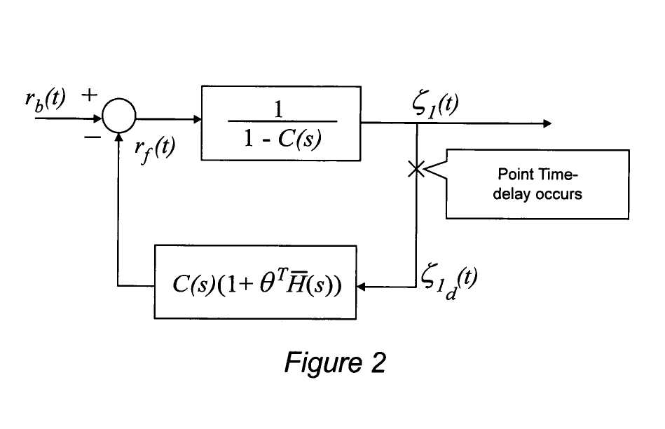

Is the one that leads to the desired system response:
\dot{x}_{ref}(t)=Aₘx_{ref}(t)+bk_{g}r(t) Eq.26
y_{ref}(t)=c^{τ}x_{ref}(t) Eq.27
by cancelling the uncertainties exactly. In the closed-loop reference system Eq.14-Eq.16, u_{ideal}(t) is further low-pass filtered by C(s) in Eq.15 to have a guaranteed low-frequency range. Thus, the reference system in Eq.14-Eq.16 has a different response as compared to Eq.26, Eq.27 with Eq.25. It should be noted that C(s) may be selected to ensure that in case of constant θ the response of x_{ref}(t), u_{ref}(t), can be made as close as possible to Eq.26 with Eq.25. In case of fast varying θ(t), it is obvious that the bandwidth of the controller needs to be matched correspondingly.
Time-Delay Margin Analysis
We consider the following LTI system with output measurement delay:

$${ζ}_{l} ( s ) = \frac{1}{1 - C ( s )} ( {r}_{b} ( s ) - {r}_{f} ( s ) ) , \\ {r}_{f} ( s ) = C ( s ) ( 1 + {θ}^{⊤} \overline{H} ( s ) ) {ζ}_{{l}_{d}} ( s ) , \qquad Eq . 28$$

where r_{b}(s) is the Laplace transformation of bounded signal r_{b}(t). The block-diagram of the closed-loop system in Eq.28 is shown in FIG. 2.

The open-loop transfer function of the system in Eq.28 is:
Hₒ(s)=C(s)(1+θ^{τ}\overline{H}(s))/(1−C(s)) Eq.29
whose phase margin P (Hₒ(s)) can be derived easily from its Bode plot. The time-delay margin of the open-loop transfer function is given by:
T (Hₒ(s))=P (Hₒ(s))/ω_{c} Eq.30
where P (Hₒ(s)) is the phase margin of the open-loop system Hₒ(s), and ω_{c} is the cross-over frequency of Hₒ(s).

With regard to the time-delay margin of the closed-loop [symbol] ₁ adaptive controller, we have:

Theorem 2: Given the system in (1) and the [symbol] ₁ adaptive controller defined via Eq.4, Eq.5-Eq.6 and Eq.7 subject to Eq.12, where Γ_{c} and Δ are large enough, the closed-loop adaptive system is stable in the presence of time delay τ in its output if τ<T (Hₒ(s)), where T (Hₒ(s)) is defined in Eq.30.

Novel Features

This new adaptive controller generates low-pass control signals. It has constructive design technique for ensuring desired bandwidth of the generated control signals. Thus, it can meet the bandwidth limitations of the actuators. It has improved transient performance. Using fast adaptation, it guarantees desired transient performance for both control signal and system response. It enables time-delay margin analysis. It has the ability to ensure convergence of tracking error to zero in the steady state performance. This new architecture permits faster rates of adaptation without generating high-frequency control signals and without destabilizing the system. It has a proof for stable performance, which is a basic requirement for every control system design. We define a new stability criterion which gives a systematic design algorithm for required specifications.

All the discussions above apply to neural adaptive controllers and higher dimensional systems, as well.

Variations

The above described architecture may be varied in several ways without departing from the spirit of the invention.

For example, if the objective is only to get rid of high frequency oscillation in the control signal, the control signal may be filtered without setting a large adaptive gain.

In another variation, the low pass filter may be applied to all or only a part of the signal

\overline{r}(t) as in (31),

$$\begin{matrix}u ( s ) = {k}_{g} r ( t ) + C ( s ) \overline{r} ( s ) , \\ where & Eq . 31 \\ \overline{r} ( t ) = \frac{- {\hat{θ}}^{⊤} ( t ) x ( t ) - \hat{σ} ( t )}{ω} . & Eq . 32\end{matrix}$$

In this variation the closed-loop reference system must also be modified. However, similar results related to transient performance can be obtained.

In a further variation, other signals can be used for scaled reference input r(t), depending on your tracking objective.

Another variation is to express the companion model and control law in other equivalent forms.

Extensions

Detailed results and proof of the [symbol] ₁ adaptive controller can be found in the attached papers. Based on [symbol] ₁ adaptive controller, [symbol] ₁ neural controller can be established which guarantees transient performance with its details in attached paper. We also note that all these results can be extended into Multiple Input Multiple Output systems easily.

Results Demonstration

As an illustrative example, consider a single-link robot arm which is rotating on a vertical plane. The system dynamics are given by:

$$I \ddot{q} ( t ) + \frac{MgL cos q ( t )}{2} + F ( t ) \dot{q} ( t ) + {F}_{1} ( t ) q ( t ) + \overline{σ} ( t ) = u ( t ) , \qquad Eq . 33$$

where

q(t) and \dot{q}(t) are measured angular position and velocity, respectively, u(t) is the input torque, I is the given moment of inertia, M is the unknown mass, L is the unknown length, F(t) is an unknown time-varying friction coefficient, F₁(t) is position dependent external torque, and
\overline{σ}(t) is an unknown bounded disturbance. The control objective is to design u(t) to achieve tracking of the bounded reference input r(t) by q(t). Let
x=[q\dot{q}]^{τ}.
The system in (33) can be presented in the state-space form as:

$$\dot{x} ( t ) = Ax ( t ) + b ( \frac{u ( t )}{I} + \frac{MgL cos ( {x}_{1} ( t ) )}{2 I} + \frac{σ ( t )}{I} + \frac{{F}_{1} ( t )}{I} {x}_{1} ( t ) + \frac{F ( t )}{I} {x}_{2} ( t ) ) , x ( 0 ) = {x}_{0} , \\ y ( t ) = {c}^{⊤} x ( t ) , \qquad Eq . 34$$

Where X₀ is the initial condition,

$$A = [ \begin{matrix}0 & 1 \\ 0 & 0\end{matrix} ] , \\ b = [ \begin{matrix}0 \\ 1\end{matrix} ] , \\ c = [ \begin{matrix}1 \\ 0\end{matrix} ] . \qquad Eq . 35$$

The system can be further put into the form:

$$\dot{x} ( t ) = {A}_{m} x ( t ) + b ( ω u ( t ) + {θ}^{⊤} ( t ) x ( t ) + σ ( t ) ) , \\ y ( t ) = {c}^{⊤} x ( t ) , x ( 0 ) = {x}_{0} , \\ where \\ {A}_{m} = [ \begin{matrix}0 & 1 \\ - 1 & - 1.4\end{matrix} ] , b = [ \begin{matrix}0 \\ 1\end{matrix} ] , c = [ \begin{matrix}1 \\ 0\end{matrix} ] , \\ w = \frac{1}{I} , \\ θ ( t ) = {[ \frac{1 + {F}_{1} ( t )}{I} 1.4 + \frac{F ( t )}{I} ]}^{⊤} , \\ σ ( t ) = \frac{MgL cos ( {x}_{1} ( t ) )}{2 I} + \frac{σ ( t )}{I} . \qquad Eq . 36$$

Let ω=1, and the unknown control effectiveness, time-varying parameters and disturbance be given by:
θ(t)=[2+cos(πt)2+0.3 sin(πt)+0.2 cos(2t)]^{τ};
σ(t)=sin(πt) Eq.37
so that the compact sets can be conservatively chosen as
Θ=[−10,10],Δ=[−10,10]. Eq.38

For implementation of the [symbol] ₁ adaptive controller Eq.4, Eq.5-Eq.6 and Eq.7, we need to verify the [symbol] ₁ stability requirement in Eq.12. Letting
C(s)=ω_{α}/(s+ω_{α}),
we have

$$\begin{matrix}G ( s ) = \frac{{ω}_{α}}{s + {ω}_{α}} H ( s ) , \\ where & Eq . 39 \\ H ( s ) = [ \begin{matrix}\frac{1}{{s}^{2} + 1.4 s + 1} \\ \frac{s}{{s}^{2} + 1.4 s + 1}\end{matrix} ] . & Eq . 40\end{matrix}$$

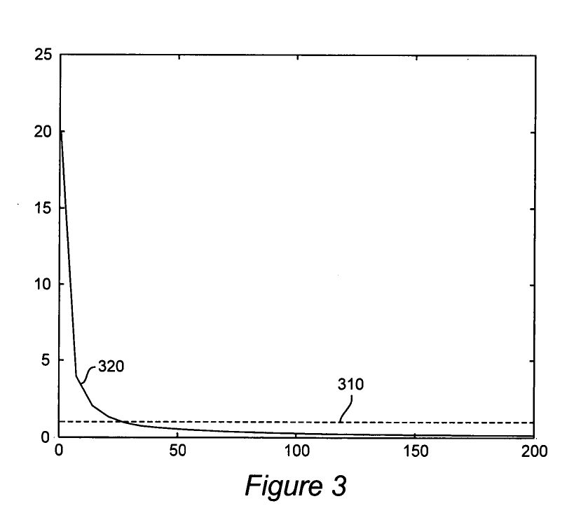

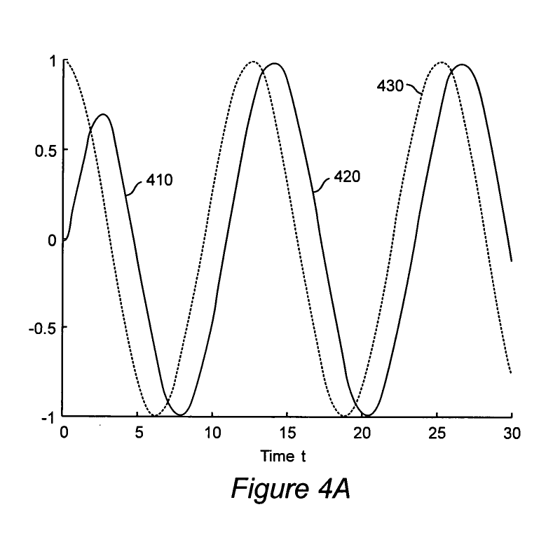

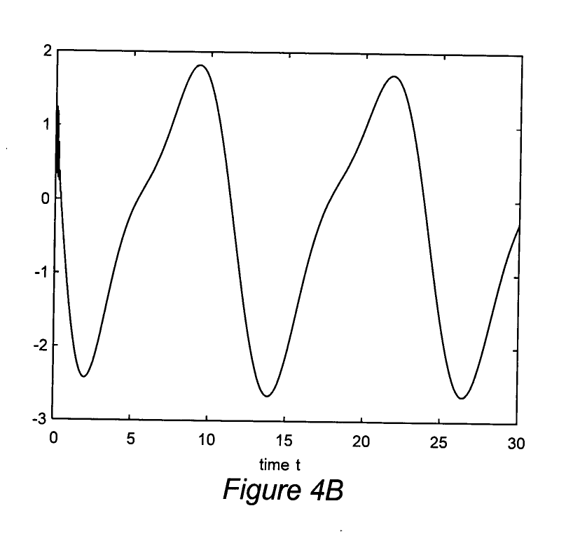

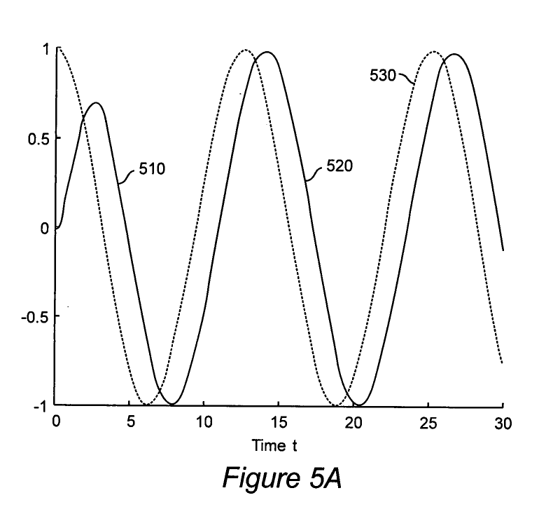

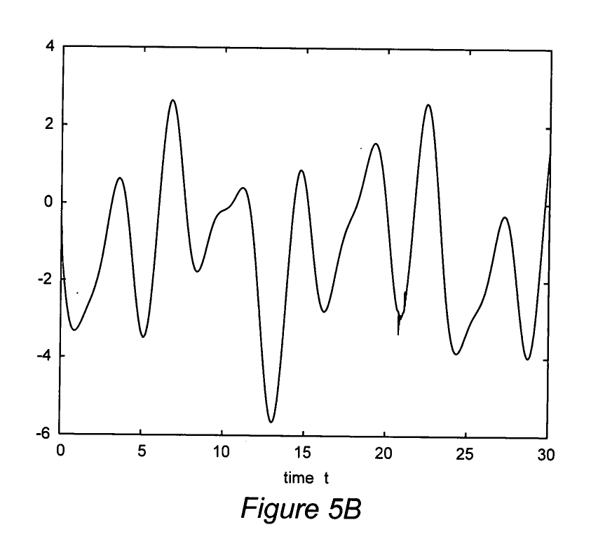

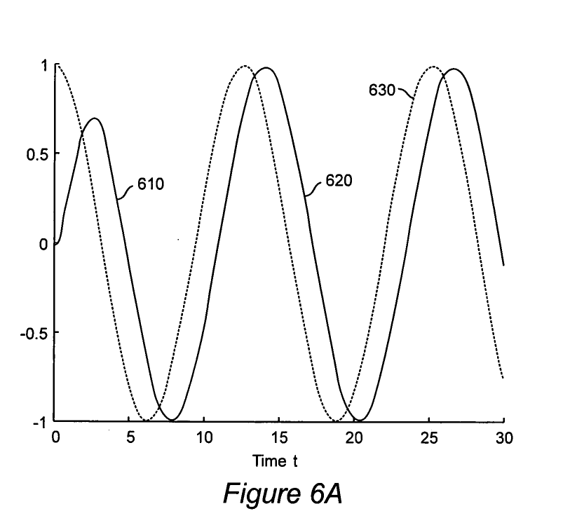

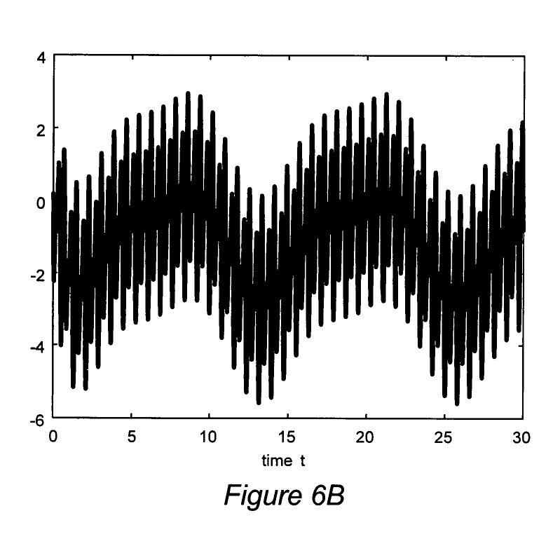

We can check easily that for our selection of compact sets in Eq.38, the resulting L=20 in Eq.11. As shown in FIG. 3, a plot 320 of
∥G(s)∥ [symbol] _{₁}L as a function of ωₖ and compare it to 1 (item 310). We notice that for ωₖ>30, we have
   ∥G(s)∥ [symbol] _{₁}L<1
   Finally, we set the adaptive gain as Γ_{c}=10000.

Turning now to FIGS. 4a and 4b, we see the simulation results of the [symbol] ₁ adaptive controller for the reference input r=cos(πt). FIG. 4a shows graphs of the system state vector 410, the companion model 420 of the invention, and the bounded reference signal 430. FIG. 4b is a graph showing the time history of the control signal u(t) where a time varying disturbance signal is
σ(t)=sin(πt).

Next, we consider a different disturbance signal:
σ(t)=cos(x₁(t))+2 sin(10t)+cos(15t).

The simulation results are shown in FIGS. 5a and 5b. FIG. 5a shows graphs of the system state vector 510, the companion model 520 of the invention, and the bounded reference signal 530. FIG. 5b is a graph showing the time history of the control signal u(t).

Finally, we consider much higher frequencies in the disturbance:
σ(t)=cos(x₁(t))+2 sin(100t)+cos(150t).

The simulation results are shown in FIGS. 6a and 6b. FIG. 6a shows graphs of the system state vector 610, the companion model 620 of the invention, and the bounded reference signal 630. FIG. 6b is a graph showing the time history of the control signal u(t).

We note that the [symbol] ₁ adaptive controller guarantees smooth and uniform transient performance in the presence of different unknown nonlinearities and time-varying disturbances. The controller frequencies are exactly matched with the frequencies of the disturbance that it is supposed to cancel out. We also notice that the system state vector signal
x₁(t)
and the companion model signal
\hat{x}₁(t)
are almost the same in FIGS. 4a, 5a and 6a.

We will now present an implementation of the invention, providing further detail and adaptations.

### I. Introduction

As described above, transient performance in the implementation can be characterized both for the system input and output signals. To achieve this, a Companion Model Adaptive Control (CMAC) architecture is introduced and its equivalence to MRAC is shown. The difference between CMAC and MRAC is in definition of the error signal for adaptive laws, which consequently allows for incorporation of a low-pass filter in the feedback loop of CMAC and enables us to enforce the desired transient performance by increasing adaptation gain. For proof of asymptotic stability, the [symbol] ₁ gain of a cascaded system, comprised of this filter and the closed-loop desired transfer function, is required to be less than the inverse of the upper bound on the norm of unknown parameters used in projection based adaptation laws. Thus, with the low-pass filter in the loop, the [symbol] ₁ adaptive controller is guaranteed to stay in the low-frequency range even in the presence of high adaptive gains and large reference inputs. The ideal (non-adaptive) version of this [symbol] ₁ adaptive controller is used along with the main system dynamics to define a closed-loop reference system, which gives an opportunity to estimate performance bounds in terms of [symbol] _{∞} norms for both system's input and output signals as compared to the same signals of this reference system. These bounds immediately imply that the transient performance of the control signal in MRAC cannot be characterized. Design guidelines for selection of the low-pass filter ensure that the closed-loop reference system approximates the desired system response, despite the fact that it depends upon the unknown parameter. Thus, the desired tracking performance is achieved by systematic selection of the low-pass filter, which in its turn enables fast adaptation, as opposed to high-gain designs leading to increased control efforts.

The paper is organized as follows. Section II states some preliminary definitions, and Section III gives the problem formulation. In Section IV, we recall the conventional MRAC design and introduce the Companion Model Adaptive Controller (CMAC), which is a reparameterization of MRAC. In Section V, a new [symbol] ₁ adaptive controller is presented. Stability and tracking results of the [symbol] ₁ adaptive controller are presented in Section VI. Comparison of the performance of [symbol] ₁ adaptive controller, MRAC and the high gain controller are discussed in section VIII. In section IX, simulation results are presented, while Section X concludes the paper.

### II. Preliminaries

In this Section, we recall some basic definitions and facts from linear systems theory.

Definition 1: For a signal ξ(t), t≧0, ξεIRⁿ, its truncated [symbol] _{∞} norm and [symbol] _{∞} norm are defined as

$${‖ {ξ}_{t} ‖}_{{ℒ}_{∞}} = {max}_{i = 1 , … , n} ( {sup}_{0 \leq τ \leq t} \vert {ξ}_{i} ( τ ) \vert ) , {‖ ξ ‖}_{{ℒ}_{∞}} = {max}_{i = 1 , … , n} ( {sup}_{τ \geq 0} \vert {ξ}_{i} ( τ ) \vert ) ,$$

where ξᵢ is the i^{th} component of ξ.

Definition 2: The [symbol] ₁ gain of a stable proper single-input single-output system H(s) is defined to be ∥H(s)∥ [symbol] _{₁}=∫₀^{∞}|h(t)|dt, where h(t) is the impulse response of H(s), computed via the inverse Laplace transform

$$h ( t ) = \frac{1}{2 π i} {\int }_{α - i ∞}^{α + i ∞} H ( s ) {e}^{st} ⅆ s , t \geq 0 ,$$

in which the integration is done along the vertical line x=α>0 in the complex plane.

Proposition: A continuous time LTI system (proper) with impulse response h(t) is stable if and only if ∫₀^{∞}|h(τ)|dτ<∞. A proof can be found in [1] (page 81, Theorem 3.3.2).

Definition 3: For a stable proper m input n output system H(s) its [symbol] ₁ gain is defined as

$${‖ H ( s ) ‖}_{{ℒ}_{1}} = {max}_{i = 1 , … , n} ( {\sum }_{j = 1}^{m} {‖ {H}_{ij} ( s ) ‖}_{{ℒ}_{1}} ) , \qquad ( 1 )$$

where Hᵢⱼ(s) is the i^{th} row j^{th} column element of H(s).

The next lemma extends the results of Example 5.2. ([2], page 199) to general multiple input multiple output systems.

Lemma 1: For a stable proper multi-input multi-output (MIMO) system H(s) with input r(t)εIR^{m} and output x(t)εIRⁿ, we have
∥xₜ∥ [symbol] _{_{∞}}≦∥H∥_{₁}∥rₜ∥ [symbol] _{_{∞}}, ∀t>0. (2)
Proof. Let xᵢ(t) be the i^{th} element of x(t), rⱼ(t) be the j^{th} element of r(t), Hᵢⱼ(s) be the i^{th} row j^{th} element of H(s), and Hᵢⱼ(t) be the impulse response of Hᵢⱼ(s). Then for any t′ε[0, t], we have

$${x}_{i} ( {t}^{′} ) = {\int }_{0}^{{t}^{′}} ( {\sum }_{j = 1}^{m} {h}_{ij} ( {t}^{′} - τ ) {r}_{j} ( τ ) ) ⅆ τ . \qquad ( 3 )$$

From (3) it follows that

$$\begin{matrix}\vert {x}_{i} ( {t}^{′} ) \vert \leq {\int }_{0}^{{t}^{′}} ( {\sum }_{j = 1}^{m} \vert {h}_{ij} ( {t}^{′} - τ ) \vert \vert {r}_{j} ( τ ) \vert ) ⅆ τ \leq \\ {\int }_{0}^{{t}^{′}} ( {\sum }_{j = 1}^{m} \vert {h}_{ij} ( {t}^{′} - τ ) \vert ) ⅆ τ ( {max}_{j = 1 , … , m} {sup}_{0 \leq τ \leq {t}^{′}} \vert {r}_{j} ( τ ) \vert ) \leq \\ {\sum }_{j = 1}^{m} ( {\int }_{0}^{{t}^{′}} \vert {h}_{ij} ( τ ) \vert ⅆ τ ) ( {max}_{j = 1 , … , m} {sup}_{0 \leq τ \leq {t}^{′}} \vert {r}_{j} ( τ ) \vert ) ,\end{matrix}$$

and hence ∥xᵢ_{ₜ}∥ [symbol] _{_{∞}}≦(Σⱼ₌₁^{m}∥Hᵢⱼ(s)∥ [symbol] _{₁})∥rₜ∥_{z,900} _{_{∞}}. It follows from (1) that

$$\begin{matrix}{‖ {x}_{t} ‖}_{{ℒ}_{∞}} = {max}_{i = 1 , … , n} {‖ {x}_{{i}_{t}} ‖}_{{ℒ}_{∞}} \leq {max}_{i = 1 , … , n} ( {\sum }_{j = 1}^{m} {‖ {H}_{ij} ( s ) ‖}_{{ℒ}_{1}} ) {‖ {r}_{t} ‖}_{{ℒ}_{∞}} \\ = {‖ H ( s ) ‖}_{{ℒ}_{1}} {‖ {r}_{t} ‖}_{{ℒ}_{∞}}\end{matrix}$$

for any t≧0. The proof is complete.

Corollary 1: For a stable proper MIMO system H(s), if the input r(t)εIR^{m} is bounded, then the output x(t)εIRⁿ is also bounded as ∥x∥ [symbol] _{_{∞}}≦∥H(s)∥ [symbol] _{₁}∥τ∥ [symbol] _{_{∞}}.

Lemma 2: For a cascaded system H(s)=H₂(s)H₁(s), where H₁(s) is a stable proper system with m inputs and l outputs and H₂(s) is a stable proper system with l inputs and n outputs, we have ∥H(s)∥ [symbol] _{₁}≦∥H₂(s)∥ [symbol] _{₁}∥H₁(s)∥ [symbol] _{₁}.

Proof. Let y(t)εIRⁿ be the output of H(s)=H₁(s)H₂(s) in response to input r(t)εIR^{m}. It follows from Lemma 1 that
∥y(t)∥≦∥y∥_{_{∞}}≦∥H₂(s)∥ [symbol] _{₁}∥H₁(s)∥ [symbol] _{₁}∥r∥_{_{∞}} (4)
for any bounded r(t). Let Hᵢ(s), i=1, . . . , n be the i^{th} row of the system H(s). It follows from (1) that there exists i such that
∥H(s)∥ [symbol] _{₁}=∥Hᵢ(s)∥ [symbol] _{₁}. (5)
Let hᵢⱼ(t) be the j^{th} element of the impulse response of the system Hᵢ(s). For any T, let
rⱼ(t)=sgnhᵢⱼ(T−t), tε[0,T], ∀j=1, . . . , m. (6)
It follows from Definition 1 that ∥r∥ [symbol] _{_{∞}}=1, and hence ∥y(t)∥≦∥H₂(s)∥ [symbol] _{₁}∥H₁(s)∥ [symbol] _{₁}, ∀t≧0. For r(t) satisfying (6), we have

$$\begin{matrix}y ( T ) = {\int }_{t = 0}^{T} {\sum }_{j = 1}^{m} {h}_{ij} ( T - t ) {r}_{j} ( t ) ⅆ t \\ = {\int }_{t = 0}^{T} {\sum }_{j = 1}^{m} \vert {h}_{ij} ( T - t ) \vert ⅆ t \\ = {\sum }_{j = 1}^{m} ( {\int }_{t = 0}^{T} \vert {h}_{ij} ( t ) \vert ⅆ t ) .\end{matrix}$$

Therefore, it follows from (4) that for any T, Σⱼ₌₁^{m}(∫ₜ₌₀^{T}|hᵢⱼ(t)|dt)≦∥H₂(s)∥ [symbol] _{₁}∥H₁∥ [symbol] _{₁}. As T→∞, it follows from (5) that

$$\begin{matrix}{‖ H ( s ) ‖}_{{ℒ}_{1}} = {‖ {H}_{i} ( s ) ‖}_{{ℒ}_{1}} \\ = {lim}_{T \to ∞} {\sum }_{j = 1}^{m} ( {\int }_{t = 0}^{T} \vert {h}_{ij} ( t ) \vert ⅆ t ) \leq {‖ {H}_{2} ( s ) ‖}_{{ℒ}_{1}} {‖ {H}_{1} ( s ) ‖}_{{ℒ}_{1}} ,\end{matrix}$$

and this completes the proof.

[image]

Consider an interconnected LTI system in FIG. 7, where w₁εIRⁿ^{₁}, w₂εIRⁿ^{₂}, M(s) is a stable proper system with n₂ inputs and n₁ outputs, and Δ(s) is a stable proper system with n₁ inputs and n₂ outputs.

Theorem 1: ( [symbol] ₁ Small Gain Theorem) The interconnected system in FIG. 7 is stable if ∥M(s)∥ [symbol] _{₁}∥Δ(s)∥ [symbol] _{₁}<1.

The proof follows from Theorem 5.6 ([1], page 218), written for [symbol] ₁ gain.

Consider a linear time invariant system:
\dot{x}(t)=Ax(t)+bu(t), (7)
where xεIRⁿ, uεIR, bεIRⁿ, AεIR^{n×n} is Hurwitz, and assume that the transfer function (sI−A)⁻¹b is strictly proper and stable. Notice that it can be expressed as:

$${( sI - A )}^{- 1} b = \frac{n ( s )}{d ( s )} , \qquad ( 8 )$$

where (d(s)=det(sI−A) is a n^{th} order stable polynomial, and n(s) is a n×1 vector with its i^{th} element being a polynomial function:

$${n}_{i} ( s ) = {\sum }_{j = 1}^{n} {n}_{ij} {s}^{j - 1} \qquad ( 9 )$$

Lemma 3: If (AεIR^{n×n}, bεIRⁿ) is controllable, the matrix N with its i^{th} row j^{th} column entry nᵢⱼ is full rank.

Proof. Controllability of (A, b) for the LTI system in (7) implies that given an initial condition x(t₀)=0 and arbitrary xₜ_{₁}εIRⁿ and arbitrary t₁, there exists u(τ), τε[t₀, t₁] such that x(t₁)=xₜ_{₁}. If N is not full rank, then there exists a non-zero vector uεIRⁿ, such that u^{τ}n(s)=0. Then it follows that for x(t₀)=0 one has u^{τ}(τ)x(τ)=0, ∀_{τ}>t₀. This contradicts x(t₁)=xₜ_{₁}, in which xₜ_{₁}εIRⁿ is assumed to be an arbitrary point. Therefore, N must be full rank, and the proof is complete.

Lemma 4: If (A, b) is controllable and (sI−A)⁻¹b is strictly proper and stable, there exists cεIRⁿ such that the transfer function c^{τ}(sI−A)⁻¹b is minimum phase with relative degree one, i.e. all its zeros are located in the left half plane, and its denominator is one order larger than its numerator.
Proof. It follows from (8) that

$${{c}^{⊤} ( sI - A )}^{- 1} b = \frac{{c}^{⊤} {N [ {s}^{n - 1} … 1 ]}^{⊤}}{d ( s )} , \qquad ( 10 )$$

where NεIR^{n×n} is matrix with its i^{th} row j^{th} column entry nᵢⱼ introduced in (9). We choose \overline{c}εIRⁿ such that \overline{c}^{τ}[sⁿ⁻¹ . . . 1]^{τ} is a stable n−1 order polynomial. Since (A, b) is controllable, it follows from Lemma 3 that N is full rank. Let c=(N⁻¹)^{τ}\overline{c}. Then it follows from (10) that

$${{c}^{⊤} ( sI - A )}^{- 1} b = \frac{{{\overline{c}}^{⊤} [ {s}^{n - 1} … 1 ]}^{⊤}}{d ( s )}$$

has relative degree 1 with all its zeros in the left half plane.

### III. Problem Formulation

Consider the following single-input single-output system dynamics:
\dot{x}(t)=Ax(t)+bu(t), x(0)=x₀
y(t)=c^{τ}x(t), (11)
where xεIRⁿ is the system state vector (measurable), uεIR is the control signal, b, cεIRⁿ are known constant vectors. A is an unknown n×n matrix, yεIR is the regulated output.

The control objective is to design an adaptive controller to ensure that y(t) tracks a given bounded continuous reference signal r(t) both is transient and steady state, while all other error signals remain bounded. More rigorously, the control objective can be stated as
y(s)≈D(s)r(s), (12)
where y(s), r(s) are Laplace transformations of y(t), r(t) respectively, and D(s) is a strictly proper stable LTI system that specifies the desired transient and steady state performance.

Following the convention, we introduce the following matching assumption:

Assumption 1: There exist a Hurwitz matrix AₘεIR^{n×n} and a vector of ideal parameters θεIRⁿ such that (Aₘ, b) is controllable and Aₘ−A=bθ^{τ}. We further assume the unknown parameter θ belongs to a given compact convex set θεΩ.

In the next section, we present two equivalent control architectures that can guarantee the steady state tracking of the bounded reference input r(t). We further use one of those to develop a novel adaptive control architecture with guaranteed transient performance.

### IV. MRAC and Companion Model Adaptive Controller

A. Model Reference Adaptive Controller

Let
\dot{x}ₘ(t)=Aₘxₘ(t)+bk_{g}r(t), xₘ(0)=x₀
yₘ(t)=c^{τ}xₘ(t) (13)
be the state space representation of the desired transfer function D(s), where xₘεIRⁿ, Aₘ is an n×n matrix k_{g} is a design gain. Usually Aₘ is chosen such that the triple (Aₘ, b, c) approximates D(s) so that yₘ(s)≈D(s)r(s) with comparable transient and steady steady specifications, subject to the matching condition in Assumption 1.

Theorem 2: [MRAC] The following direct adaptive feedback/feedforward controller
u_{MRAC}(t)=\hat{θ}^{τ}(t)x(t)+k_{g}r(t), (14)
\hat{\dot{θ}}(t)=ΓProj(\hat{θ}(t), x((t)e^{τ}(t)Pb), \hat{θ}(0)=\hat{θ}₀, (15)
in which \hat{θ}(t)εIRⁿ are the adaptive parameters, Proj(•,•) denotes the projection operator, e(t)=xₘ(t)−x(t) is the tracking error, ΓεIR^{n×n} is a positive definite matrix of adaptation gains, and P=P^{τ}>0 be the solution of the algebraic equation Aₘ^{τ}P+PAₘ=−Q for arbitrary Q>0, ensures that

$${lim}_{t \to ∞} e ( t ) = 0.$$

A proof can be found in [3]. Indeed, the tracking error dynamics with the control law (14), (15) can be written as:
\dot{e}(t)=Aₘe(t)−b\tilde{θ}^{τ}(t)x(t), e(0)=0, \tilde{θ}(t) [symbol] \hat{θ}(t)−θ.(16)
Using standard Lyapunov arguments and Barbalat's lemma, one can prove that

$${lim}_{t \to ∞} e ( t ) = 0.$$

B. Companion Model Adaptive Controller

Theorem 3: [CMAC] Given a bounded reference input signal r(t) of interest to track, the following direct adaptive feedback/feedforward controller
u_{CMAC}(t)=\hat{θ}^{τ}(t)x(t)+k_{g}r(t). (17)
\hat{\dot{θ}}(t)=ΓProj(x(t)\tilde{x}^{τ}(t)Pb,\hat{θ}(t)),\hat{θ}(0)=\hat{θ}₀, (18)
in which \hat{θ}(t)εIRⁿ are the adaptive parameters, \tilde{x}(t)=\hat{x}(t)−x(t) is the tracking error between system dynamics in (11) and the following companion system
\hat{\dot{x}}(t)=Aₘ\hat{x}(t)+b(u(t)−\hat{θ}^{τ}(t)x(t)),\hat{x}(0)=x₀
ŷ(t)=c^{τ}\hat{x}(t), (19)
ensures that

$${lim}_{t \to ∞} \tilde{x} ( t ) = 0.$$

The proof is straightforward. Indeed, subject to Assumption 1, the system dynamics in (11) can be rewritten as:
\dot{x}(t)=Aₘx(t)+b(u(t)−θ^{τ}x(t)), x(0)=x₀
y(t)=c^{τ}x(t). (20)
Notice that the companion model in (19) shares the same structure with (20), while the control law in (17), (18) reduces the the closed loop dynamics of the companion model to the desired reference model in (13):
\hat{\dot{x}}(t)=Aₘ\hat{x}(t)+bk_{g}r(t), \hat{x}(0)=x₀. (21)
We also notice that the closed-loop tracking error dynamics are the same as in (16):
\tilde{\dot{x}}(t)=Aₘ\tilde{x}(t)−b\tilde{θ}^{τ}(t)x(t), \tilde{x}(0)=0. (22)
Since the closed-loop companion model in (21) is bounded, from standard Lyapunov arguments and Barbalat's lemma it follows that

$${lim}_{t \to ∞} \tilde{x} ( t ) = 0.$$

Thus, the companion model adaptive control architecture is equivalent to MRAC. The following remark is in order.

Remark 1: The matching assumption implies that the ideal tracking controller is given by the following linear relationship

$$\begin{matrix}{u}_{ideal} ( t ) = {θ}^{⊤} x ( t ) + {k}_{g} r ( t ) , \\ where & ( 23 ) \\ {k}_{g} = - \frac{1}{{c}^{⊤} {A}_{m}^{- 1} b} . & ( 24 )\end{matrix}$$

The choice of k_{g} in (24) ensures that for constant r one has

$${lim}_{t \to ∞} y ( t ) = r$$

in both architectures.
C. Bounded Tracking Error Signal

For both architectures MRAC and CMAC, one can prove that the tracking error can be rendered arbitrarily small by increasing the adaptive gain. The main result is given by the following lemma.

Lemma 5: Let Γ=Γ_{c}II, where Γ_{c}εIR⁺, and II is the identity matrix. For the system in (20)

$$‖ \breve{x} ( t ) ‖ \leq \sqrt{\frac{ {\overline{θ}}_{max}}{{λ}_{min} ( P ) {Γ}_{c}}} , {\overline{θ}}_{max} {=}^{Δ} {max}_{θ ∈ Ω} {\sum }_{i = 1}^{n} 4 {θ}_{i}^{2} , ∀ t \geq 0 , \qquad ( 25 )$$

and λₘᵢₙ(P) is the minimum eigenvalue of P.
Proof. The candidate Lyapunov function, which can be used to prove asymptotic convergence of tracking error to zero in Theorems 2 and 3, is given by V(\tilde{x}(t), \tilde{θ}(t))=\tilde{x}^{τ}(t)P\tilde{x}(t)+\tilde{θ}^{τ}(t)Γ⁻¹\tilde{θ}(t). The following upper bound is straight-forward to derive: \tilde{x}^{τ}(t)P\tilde{x}(t)≦V(t)≦V(0), ∀t≧0. The projection algorithm ensures that \hat{θ}(t)εΩ, ∀t≧0, and therefore

$${max}_{t \geq 0} {\tilde{θ}}^{⊤} ( t ) {Γ}^{- 1} \tilde{θ} ( t ) \leq \frac{ {\overline{θ}}_{max}}{{Γ}_{c}} , ∀ t \geq 0 , \qquad ( 26 )$$

where \overline{θ}ₘₐₓ is defined in (25). Since \tilde{x}(0)=0, then V(0)=\tilde{θ}^{τ}(0)Γ⁻¹\tilde{θ}(0), which leads to

$${\tilde{x}}^{⊤} ( t ) P \tilde{x} ( t ) \leq \frac{ {θ}_{max}}{{Γ}_{c}} ,$$

t≧0. Since λₘᵢₙ(P)∥\tilde{x}∥²≦\tilde{x}^{τ}(t)P\tilde{x}(t), then

$$‖ \tilde{x} ( t ) ‖ \leq \sqrt{\frac{ {\overline{θ}}_{max}}{{λ}_{min} ( P ) {Γ}_{c}}} .$$

D. Transient Performance

Theorems 2 and 3 state that the tracking error goes to zero asymptotically as t→∞. Lemma 5 states that the tracking error can be reduced by increasing the adaptation gain Γ_{c}. The following simulations demonstrate that increasing the adaptation gain Γ_{c} indeed leads to better transient tracking, but results in unacceptable high-frequency oscillations in the control signal. For simulation purposes, the following system parameters have been selected:

$$A = [ \begin{matrix}0 & 1 \\ - 5 & 3.1\end{matrix} ] , {A}_{m} = [ \begin{matrix}0 & 1 \\ - 1 & - 1.4\end{matrix} ] , \\ b = {[ 0 \; 1 ]}^{⊤} , c = {[ 1 \; 0 ]}^{⊤} , θ = {[ 4 - 4.5 ]}^{⊤} .$$

The choice of Γ_{c}=0.04 and Q=I leads to desired tracking performance for the reference input r=100, FIGS. 2(a), 2(b). FIGS. 2(c) and 2(d) demonstrate that increasing the adaptive gain improves the transient tracking at the price of high frequency oscillations in the control signal.

FIGS. 3(a) and 3(b) plot the response of the adaptive controller to reference input r=400, without retuning of the adaptive controller. The response to reference input r=25 without retuning the control parameters results in slow convergence, FIGS. 4(a) and 4(b).

These simulations imply two important messages: a) increasing the adaptation gain leads to improved transient tracking performance at the price of high-frequency oscillations in the control signal, b) every change in the reference input implies that retuning of adaptive controller needs to be done to recover the transient tracking performance. Similar deterioration in the transient tracking performance can be observed if one changes the unknown parameters in the system or the initial conditions. Otherwise saying, there is no systematic way of selecting design parameters that would yield the desired transient performance for all possible changes in the system dynamics. On the other hand, the bandwidth limitations of mechanical actuators render implementation of high-frequency control signals

[image]

overly challenging. Even if implemented, high-frequency control signal can easily excite the high-frequency dynamics of the system, omitted in the modeling, and lead to destabilization.

[image]

### V. ₁ Adaptive Controller

In this section, we develop a novel adaptive control architecture that permits complete transient characterization for both system input and output signals. Towards that end, notice that using the matching condition in Assumption 1 the dynamics in (11) can be rewritten as in (20):
\dot{x}(t)=Aₘx(t)−bθ^{τ}x(t)+bu(t), x(0)=x₀
y(t)=c^{τ}x(t). (27)
The following control structure
u(t)=u₁(t)+u₂(t), u₁(t)=−K^{τ}x(t), (28)
where u₂(t) is the adaptive controller to be determined later, while K is a nominal design gain and can be set to zero, leads to the following partially closed-loop dynamics:
\dot{x}(t)=Aₒx(t)−bθ^{τ}x(t)+bu₂(t), x(0)=x₀
y(t)=c^{τ}x(t). (29)
The choice of K needs to ensure that Aₒ=Aₘ−bK^{τ} is Hurwitz or, equivalently, that
Hₒ(s)=(sI−Aₒ)⁻¹b (30)
is stable. One obvious choice is K=0. For the linearly parameterized system in (29), we consider the following companion model
\hat{\dot{x}}(t)=Aₒ\hat{x}(t)+b(u₂(t)−\hat{θ}^{τ}(t)x(t)), \hat{x}(0)=x₀
ŷ(t)=c^{τ}\hat{x}(t) (31)
along with the adaptive law for \hat{θ}(t):
\hat{\dot{θ}}(t)=ΓProj(x(t)\tilde{x}^{τ}(t)Pₒb,\hat{θ}(t)), \hat{θ}(0)=\hat{θ}₀, (32)
where \tilde{x}(t)=\hat{x}(t)−x(t) is the tracking error, ΓεIR^{n×n}=Γ_{c}I_{n×n} is the matrix of adaptation gains, and Pₒ is the solution of the algebraic equation Aₒ^{τ}Pₒ+PₒAₒ=−Qₒ, Qₒ>0.

Letting
\overline{r}(t)=\hat{θ}^{τ}(t)x(t), (33)
the companion model in (31) can be viewed as a low-pass system with u(t) being the control signal, \overline{r}(t) being a time-varying disturbance, which is not prevented from having high-frequency oscillations. Instead of (17), we consider the following control design for (31):
u₂(s)=C(s)(\overline{r}(s)+k_{g}r(s)), (34)
where u₂(s), \overline{r}(s), r(s) are the Laplace transformations of u₂(t), \overline{r}(t), r(t), respectively, C(s) is a stable and strictly proper system with low-pass gain C(0)=1, and k_{g} is

$${k}_{g} = {lim}_{s ⇀ 0} \frac{1}{{c}^{⊤} {H}_{o} ( s )} = \frac{1}{{c}^{⊤} {H}_{o} ( 0 )} . \qquad ( 35 )$$

The complete [symbol] ₁ adaptive controller consists of (28), (31), (32), (34), and closed-loop system with it is illustrated in FIG. 11.

Consider the closed-loop companion model in (31) with the control signal defined in (34). It can be viewed as an LTI system with two inputs r(t) and

[image]

\overline{r}(t):
\hat{x}(s)=\overline{G}(s)\overline{r}(s)+G(s)r(s) (36)
\overline{G}(s)=Hₒ(s)(C(s)−1) (37)
G(s)=k_{g}Hₒ(s)C(s), (38)
where \hat{x}(s), \overline{r}(s) are the Laplace transformations of the signals \hat{x}(t), \overline{r}(t), respectively. We note that \overline{r}(t) is related to \hat{x}(t), u(t) and r(t) via nonlinear relationships.

Remark 2: Since both Hₒ(s) and C(s) are strictly proper stable systems, one can check easily that \overline{G}(s) and G(s) are strictly proper stable systems, even though that 1−C(s) is proper.
Let

$${θ}_{max} = {max}_{θ ∈ Ω} {\sum }_{i = 1}^{n} \vert {θ}_{i} \vert , \qquad ( 39 )$$

where θᵢ is the i^{th} element of θ. Ω is the compact set, where the unknown parameter lies. We now give the [symbol] ₁ performance requirement that ensures stability of the entire system and desired transient performance, as discussed later in Section VI.

[symbol] ₁-gain requirement: Design K and C(s) to satisfy
∥\overline{G}(s)∥ [symbol] _{₁}θₘₐₓ<1. (40)

### VI. Analysis of ₁ Adaptive Controller

A. Stability and Asymptotic Convergence

Consider the following Lyapunov function candidate:
V(\hat{x}(t), \tilde{θ}(t))=\tilde{x}^{τ}(t)Pₒ\tilde{x}(t)+\hat{θ}^{τ}(t)Γ⁻¹\tilde{θ}(t), (41)
where Pₒ and Γ are introduced in (32). It follows from (29) and (31) that
\hat{\dot{x}}(t)=Aₒ\tilde{x}(t)−b\tilde{θ}^{τ}(t)x(t), \tilde{x}(0)=0. (42)
Hence, it is straightforward to verify from (32) that
\dot{V}(t)≦−\tilde{x}^{τ}(t)Qₒ\tilde{x}(t)≦0. (43)
Notice that the result in (43) is independent of u₂(t), and, hence, Lemma 5 also holds for the [symbol] ₁ adaptive controller along with its adaptive law in (32). However, one cannot deduce stability from it. One needs to prove in addition that with the [symbol] ₁ adaptive controller the state of the companion model will remain bounded. Boundedness of the system state then will follow.

Theorem 4: Given the system in (27) and the [symbol] ₁ adaptive controller defined via (28), (31), (32), (34) subject to (40), the tracking error \tilde{x}(t) converges to zero asymptotically:

$${lim}_{t ⇀ ∞} \breve{x} ( t ) = 0. \qquad ( 44 )$$

Proof. Let λₘᵢₙ(Pₒ) be the minimum eigenvalue of Pₒ. From (41) and (43) it follows that
λₘᵢₙ(Pₒ)∥\tilde{x}(t)∥²≦\tilde{x}^{τ}(t)Pₒ\tilde{x}(t)≦V(t)≦V(0),
implying that

$${‖ \tilde{x} ( t ) ‖}^{2} \leq \frac{V ( 0 )}{{λ}_{min} ( {P}_{o} )} , t \geq 0. \qquad ( 45 )$$

From Definition 1,

$${‖ \tilde{x} ‖}_{{ℒ}_{∞}} = {max}_{i = 1 … , n , t \geq 0} \vert {\tilde{x}}_{i} ( t ) \vert .$$

The relationship in (45) ensures that

$${max}_{i = 1 , … , n , t \geq 0} \vert {\tilde{x}}_{i} ( t ) \vert \leq \sqrt{\frac{V ( 0 )}{{λ}_{min} ( {P}_{o} )}} ,$$

and therefore for all t>0 one has

$${‖ {\tilde{x}}_{t} ‖}_{{ℒ}_{ ∞}} \leq \sqrt{\frac{V ( 0 )}{{λ}_{min} ( {P}_{o} )}} .$$

Using the triangular relationship for norms implies that

$$\vert {‖ {\hat{x}}_{t} ‖}_{{ℒ}_{ ∞}} = {‖ {x}_{t} ‖}_{{𝔷}_{ ∞}} \vert \leq \sqrt{\frac{V ( 0 )}{{λ}_{min} ( {P}_{o} )}} . \qquad ( 46 )$$

The projection algorithm in (15) ensures that \hat{θ}(t)εΩ, ∀t≧0. The definition of \overline{r}(t) in (33) implies that ∥\overline{r}ₜ∥ [symbol] _{_{∞}}≦θₘₐₓ∥xₜ∥_{_{∞}}. Substituting for ∥xₜ∥ [symbol] _{_{∞}} from (46) leads to the following

$${‖ {\overline{r}}_{t} ‖}_{{𝔷}_{ ∞}} \leq {θ}_{max} ( {‖ {\hat{x}}_{t} ‖}_{{ℒ}_{ ∞}} + \sqrt{\frac{V ( 0 )}{{λ}_{min} ( {P}_{o} )}} ) . \qquad ( 47 )$$

It follows from Lemma 1 that ∥\hat{x}ₜ∥ [symbol] _{_{∞}}≦∥\overline{G}(s)∥ [symbol] _{₁}∥\overline{r}ₜ∥ [symbol] _{_{∞}}+∥G(s)∥ [symbol] _{₁}∥rₜ∥ [symbol] _{_{∞}}, which along with (47) gives the following upper bound

$$\begin{matrix}{‖ {\hat{x}}_{t} ‖}_{{ℒ}_{ ∞}} \leq {‖ \overline{G} ( s ) ‖}_{{𝔷}_{ 1}} {θ}_{max} ( {‖ {\hat{x}}_{t} ‖}_{{ℒ}_{ ∞}} + \sqrt{\frac{V ( 0 )}{{λ}_{min} ( {P}_{o} )}} ) + {‖ G ( s ) ‖}_{{𝔷}_{ 1}} {‖ {r}_{t} ‖}_{{ℒ}_{ ∞}} . \\ Let & ( 48 ) \\ λ = {‖ \overline{G} ( s ) ‖}_{{𝔷}_{ 1}} {θ}_{max} . & ( 49 )\end{matrix}$$

From (40) it follows that λ<1. The relationship in (48) can be written as

$$( 1 - λ ) {‖ {\hat{x}}_{t} ‖}_{{ℒ}_{ ∞}} \leq λ \sqrt{\frac{V ( 0 )}{{λ}_{min} ( {P}_{o} )}} + {‖ G ( s ) ‖}_{{𝔷}_{ 1}} {‖ {r}_{t} ‖}_{{ℒ}_{ ∞}} ;$$

and hence

$${‖ {\hat{x}}_{t} ‖}_{{ℒ}_{ ∞}} \leq \frac{λ \sqrt{\frac{V ( 0 )}{{λ}_{min} ( {P}_{o} )}} + {‖ G ( s ) ‖}_{{𝔷}_{ 1}} {‖ {r}_{t} ‖}_{{ℒ}_{ ∞}}}{1 - λ} . \qquad ( 50 )$$

Since V(0), λₘᵢₙ(Pₒ), ∥G(s)∥ [symbol] _{_{∞}}, λ are all finite and λ<1, the relationship in (50) implies that ∥\hat{x}ₜ∥ [symbol] _{_{∞}} is finite for any t>0, and hence \hat{x}(t) is bounded. The relationship in (46) implies that ∥xₜ∥ [symbol] _{_{∞}} is also finite for all t>0, and therefore [image]
x(t) is bounded. The adaptive law in (32) ensures that the estimates \hat{θ}(t) are also bounded. Hence, it can be checked easily from (22) that \tilde{\dot{x}}(t) is bounded, and it follows from Barbalat's lemma that

$${lim}_{t \to ∞} \tilde{x} ( t ) = 0.$$

B. Reference System

In this section we characterize the reference system that the [symbol] ₁ adaptive controller in (28), (31), (32), (34) tracks both in transient and steady state, and this tracking is valid for system's both input and output signals. Towards that end, consider the following ideal version of the adaptive controller in (28), (34):
u_{ref}(s)=C(s)(k_{g}r(s)+θ^{τ}x_{ref}(s))−K^{τ}x_{ref}(s), (51)
where x_{ref}(s) is used to denote the Laplace transformation of the state x_{ref}(t) of the closed-loop system. The closed-loop system (20) with the controller (51) is given in FIG. 12.

Remark 3: Notice that when C(s)=1 and K=0, one recovers the reference model of MRAC, and the controller in (51) reduces to the one in (23). If C(s)≠1 and K≠0, then the control law in (51) changes the bandwidth of u_{ideal}(t)=θ^{τ}x(t)+k_{g}r(t) in (23).

The control law in (51) leads to the following closed-loop dynamics:
x_{ref}(s)=Hₒ(s)(k_{g}C(s)r(s)+(C(s)−1)θ^{τ}x_{ref}(s))
y_{ref}(s)=c^{τ}x_{ref}(s), (52)
which can be explicitly solved for x_{ref}(s):
x_{ref}(s)=(I−(C(s)−1)Hₒ(s)θ^{τ})⁻¹Hₒ(s)k_{g}C(s)r(s).
Hence, it follows from (37) and (38) that
x_{ref}(s)=(I−\overline{G}(s)θ^{τ})⁻¹G(s)r(s). (53)
Lemma 6: If ∥\overline{G}(s)∥ [symbol] _{₁}θₘₐₓ<1, then
(i) (I−\overline{G}(s)θ^{τ})⁻¹ is stable;
(ii) (I−\overline{G}(s)θ^{τ})⁻¹G(s) is stable. (54)
Proof. It follows from (1) that

$${‖ \overline{G} ( s ) {θ}^{⊤} ‖}_{{𝔷}_{ 1}} = {max}_{i = 1 , … , n} ( {‖ {\overline{G}}_{i} ( s ) ‖}_{{𝔷}_{ 1}} ( {\sum }_{j = 1}^{n} \vert {θ}_{j} \vert ) ) ,$$

where \overline{G}ᵢ(s) is the i^{th} element of G(s), and θⱼ is the j^{th} element of θ. From (39) we have Σⱼ₌₁ⁿ|θⱼ|≦θₘₐₓ, and hence

$${‖ \overline{G} ( s ) {θ}^{⊤} ‖}_{{ℒ}_{1}} \leq {max}_{i = 1 … , n} ( {‖ {\overline{G}}_{i} ( s ) ‖}_{{ℒ}_{1}} ) {θ}_{max} = {‖ \overline{G} ( s ) ‖}_{{ℒ}_{1}} {θ}_{max} , ∀ θ ε Ω . \qquad ( 55 )$$

∥\overline{G}(s)θ^{τ}∥ [symbol] _{₁}<1, Thus, Theorem 1 ensures that the LTI system (I−\overline{G}(s)θ^{τ})⁻¹ is stable. Since G(s) is stable, then it follows from Remark 2 that (I−\overline{G}(s)θ^{τ})⁻¹G(s) is stable.
C. System Response and Control Signal of the [symbol] ₁ Adaptive Controller

Letting
r₁(t)=\tilde{θ}^{τ}(t)x(t), (56)
we notice that \overline{r}(t) in (33) can be rewritten as \overline{r}(t)=θ^{τ}(\hat{x}(t)−\tilde{x}(t))+r₁(t). Hence, the companion model in (36) can be rewritten as \hat{x}(s)=\tilde{G}(s)(θ^{τ}\hat{x}(s)−θ^{τ}\tilde{x}(s)+r₁(s))+G(s)r(s), where r₁(s) is the Laplace transformation of r₁(t) defined in (56), and further put into the form:
\hat{x}(s)=(I−\overline{G}(s)θ^{τ})⁻¹(−\overline{G}(s)θ^{τ}\tilde{x}(s)+\overline{G}(s)r₁(s)+G(s)r(s)). (57)
It follows from (42) and (56) that \tilde{\dot{x}}(t)=Aₒ\tilde{x}(t)−br₁(t), and hence
\tilde{x}(s)=−Hₒ(s)r₁(s). (58)
Using the expression of \overline{G}(s) from (37), the state of the companion model can be presented as
\hat{x}(s)=(I−\overline{G}(s)θ^{τ})⁻¹(−\overline{G}(s)θ^{τ}\tilde{x}(s)−(C(s)−1)\tilde{x}(s)+G(s)r(s)),
which can be further put into the form:
\hat{x}(s)=(I−\overline{G}(s)θ^{τ})⁻¹G(s)r(s)+(I−\overline{G}(s)θ^{τ})⁻¹(−\overline{G}(s)θ^{τ}\tilde{x}(s)−(C(s))−1)\tilde{x}(s)).
Using x_{ref}(s) from (53) and recalling the definition of \tilde{x}(s)=\hat{x}(s)−x(s), one arrives at
x(s)=x_{ref}(s)−(I+(I−\overline{G}(s)θ^{τ})₋₁(\overline{G}(s)θ^{τ}+(C(s)−1)I))\tilde{x}(s). (59)
The expressions in (28), (34) and (51) lead to the following expression of the control signal
u(s)=u_{ref}(s)+C(s)r₁(s)+(C(s)θ^{τ}−K^{τ})(x(s)−xᵣ(s)). (60)
D. Asymptotic Performance and Steady State Error

Theorem 5: Given the system in (27) and the [symbol] ₁ adaptive controller defined via (28), (31), (32), (34) subject to (40), we have:

$$\begin{matrix}{lim}_{ t \to ∞} ‖ x ( t ) - {x}_{ ref} ( t ) ‖ = 0 , & ( 61 ) \\ {lim}_{ t \to ∞} \vert u ( t ) - {u}_{ref} ( t ) \vert = 0. & ( 62 )\end{matrix}$$

Proof. Let
r₂(s)=(I+(I−\overline{G}(s)θ^{τ})⁻¹(\overline{G}(s)θ^{τ}+(C(s)−1)I))\tilde{x}(s). (63)
It follows from (59) that
r₂(t)=x_{ref}(t)−x(t). (64)
The signal r₂(t) can be viewed as the response of the LTI system
H₂(s)=I+(I−\overline{G}(s)θ^{τ})⁻¹(\overline{G}(s)θ^{τ}+(C(s)−1)I) (65)
to the bounded error signal \tilde{x}(t). It follows from (54) and Remark 2 that (I−\overline{G}(s)θ^{τ})⁻¹, \overline{G}(s), C(s) are stable and, therefore, H₂(s) is stable. Hence, from (44) we have

$${lim}_{ t \to ∞} {r}_{2} ( t ) = 0.$$

Let
r₃(s)=C(s)r₁(s)+(C(s)θ^{τ}−K^{τ})(x(s)−xᵣ(s)). (66)
It follows from (60) that
r₃(t)=u(t)−u_{ref}(t). (67)
Since the projection operator ensures that \tilde{θ}(t) is bounded, it follows from (42) and (44) that

$${lim}_{t \to ∞} {r}_{1} ( t ) = 0.$$

Since C(s) is a stable proper system, it follows from (61) that

$${lim}_{t \to ∞} {r}_{3} ( t ) = 0.$$

Lemma 7: Given the system in (27) and the [symbol] ₁ adaptive controller defined via (28), (31), (32), (34) subject to (40), if r(t) is constant, then

$${lim}_{t \to ∞} y ( t ) = r .$$

Proof. Since
y_{ref}(t)=c^{τ}x_{ref}(t), (68)
it follows from (61) that

$${lim}_{t \to ∞} ( y ( t ) - {y}_{ref} ( t ) ) = 0. \qquad ( 69 )$$

From (53) it follows that y_{ref}(s)=c^{τ}(I−\overline{G}(s)θ^{τ})⁻¹G(s)r(s). The end value theorem ensures

$${lim}_{t \to ∞} {y}_{ref} ( t ) = {lim}_{s \to 0} {{c}^{⊤} ( I - \overline{G} ( s ) {θ}^{⊤} )}^{- 1} G ( s ) r = {c}^{⊤} {H}_{o} ( 0 ) C ( 0 ) {k}_{g} r . \qquad ( 70 )$$

Definition of k_{g} in (35) leads to

$${lim}_{t \to ∞} y ( t ) = r .$$

In addition to the constant reference input signal r, we need to characterize the closed-loop system response with the [symbol] ₁ controller to a time varying input r(t). This is analyzed in the following sections.

E. Transient Performance

We note that (Aₘ−bK^{τ}, b) is the state space realization of Hₒ(s). Since (Aₘ, b) is controllable, it can be proved easily that (Aₘ−bK^{τ}, b) is also controllable. It follows from Lemma 4 that there exists cₒεIRⁿ such that

$${c}_{o}^{⊤} {H}_{o} ( s ) = \frac{{N}_{n} ( s )}{{N}_{d} ( s )} , \qquad ( 71 )$$

where the order of N_{d}(s) is one more than the order of Nₙ(s), and both Nₙ(s) and N_{d}(s) are stable polynomials.

Theorem 6: Given the system in (27) and the [symbol] ₁ adaptive controller defined via (28), (31), (32), (34) subject to (40), we have:

$$\begin{matrix}{‖ x - {x}_{ref} ‖}_{{ℒ}_{∞}} \leq \frac{{γ}_{1}}{\sqrt{{Γ}_{c}}} , & ( 72 ) \\ {‖ y - {y}_{ref} ‖}_{{ℒ}_{∞}} \leq {‖ {c}^{⊤} ‖}_{{ℒ}_{1}} \frac{{γ}_{1}}{\sqrt{{Γ}_{c}}} , & ( 73 ) \\ {‖ u - {u}_{ref} ‖}_{{ℒ}_{∞}} \leq \frac{{γ}_{2}}{\sqrt{{Γ}_{c}}} , & ( 74 )\end{matrix}$$

where ∥c^{τ}∥ [symbol] _{₁} is the [symbol] ₁ gain of c^{τ} and

$$\begin{matrix}{γ}_{1} = {‖ {H}_{2} ( s ) ‖}_{{ℒ}_{1}} \sqrt{\frac{{\overline{θ}}_{max}}{{λ}_{max} ( {P}_{o} )}} , & ( 75 ) \\ {γ}_{2} = {‖ C ( s ) \frac{1}{{c}_{o}^{⊤} {H}_{o} ( s )} {c}_{o}^{⊤} ‖}_{{ℒ}_{1}} \sqrt{\frac{{\overline{θ}}_{max}}{{λ}_{max} ( {P}_{o} )}} + {‖ C ( s ) {θ}^{⊤} - {K}^{⊤} ‖}_{{ℒ}_{1}} {γ}_{1} . & ( 76 )\end{matrix}$$

Proof. It follows from (63), (65) and Lemma 1 that ∥r₂∥ [symbol] _{_{∞}}≦∥H₂(s)∥ [symbol] _{₁}∥\tilde{x}∥ [symbol] _{_{∞}}, while Lemma 5 implies that

$${‖ \tilde{x} ‖}_{{ℒ}_{∞}} \leq \sqrt{\frac{{\overline{θ}}_{max}}{{λ}_{max} ( {P}_{o} ) {Γ}_{c}}} . \qquad ( 77 )$$

Therefore,

$${‖ {r}_{2} ‖}_{{𝔷}_{∞}} \leq {‖ {H}_{2} ( s ) ‖}_{{𝔷}_{1}} \sqrt{\frac{{\overline{θ}}_{max}}{{λ}_{max} ( {P}_{o} ) {Γ}_{c}}} ,$$

which leads to (72). The upper bound in (73) follows from (72) and Lemma 2 directly. From (58) we have

$$\begin{matrix}{r}_{3} ( s ) = C ( s ) \frac{1}{{c}_{o}^{T} {H}_{o} ( s )} {c}_{o}^{⊤} {H}_{o} ( s ) {r}_{1} ( s ) + ( C ( s ) {θ}^{⊤} - {K}^{⊤} ) ( x ( s ) - {x}_{r} ( s ) ) \\ = - C ( s ) \frac{1}{{c}_{o}^{⊤} {H}_{o} ( s )} {c}_{o}^{⊤} \tilde{x} ( s ) + ( C ( s ) {θ}^{⊤} - {K}^{⊤} ) ( x ( s ) - {x}_{r} ( s ) ) ,\end{matrix}$$

where cₒ is introduced in (71). It follows from (71) that

$$C ( s ) \frac{1}{{c}_{o}^{⊤} {H}_{o} ( s )} = C ( s ) \frac{{N}_{d} ( s )}{{N}_{n} ( s )} ,$$

where N_{d}(s), in Nₙ(s) are stable polynomials and the order of Nₙ(s) is one less than the order of N_{d}(s). Since C(s) is stable and strictly proper, the complete system

$$C ( s ) \frac{1}{{c}_{o}^{⊤} {H}_{o} ( s )}$$

is proper and stable, which implies that its [symbol] ₁ gain exists and is finite. Hence, we have

$${‖ {r}_{3} ‖}_{{𝔷}_{∞}} \leq {‖ C ( s ) \frac{1}{{c}_{o}^{⊤} {H}_{o} ( s )} {c}_{o}^{⊤} ‖}_{{𝔷}_{1}} {‖ \tilde{x} ‖}_{{𝔷}_{∞}} + {‖ C ( s ) {θ}^{⊤} - {K}^{⊤} ‖}_{{𝔷}_{1}} {‖ x - {x}_{r} ‖}_{{𝔷}_{∞}} .$$

Lemma 5 leads to the upper bound in (74):

$${‖ {r}_{3} ‖}_{{𝔷}_{∞}} \leq {‖ C ( s ) \frac{1}{{c}_{o}^{⊤} {H}_{o} ( s )} {c}_{o}^{⊤} ‖}_{{𝔷}_{1}} \sqrt{\frac{{\overline{θ}}_{max}}{{λ}_{max} ( {P}_{o} ) {Γ}_{c}}} + {‖ C ( s ) {θ}^{⊤} - {K}^{⊤} ‖}_{{𝔷}_{1}} {‖ x - {x}_{r} ‖}_{{𝔷}_{∞}} .$$

Corollary 2: Given the system in (27) and the [symbol] ₁ adaptive controller defined via (28), (31), (32), (34) subject to (40), we have:

$$\begin{matrix}\begin{matrix}{lim}_{{Γ}_{c} -> ∞} ( x ( t ) - {x}_{ref} ( t ) ) = 0 , & ∀ t \geq 0 ,\end{matrix} & ( 78 ) \\ \begin{matrix}{lim}_{{Γ}_{c} -> ∞} ( y ( t ) - {y}_{ref} ( t ) ) = 0 , & ∀ t \geq 0 ,\end{matrix} & ( 79 ) \\ \begin{matrix}{lim}_{{Γ}_{c} -> ∞} ( u ( t ) - {u}_{ref} ( t ) ) = 0 , & ∀ t \geq 0.\end{matrix} & ( 80 )\end{matrix}$$

Corollary 2 states that x(t), y(t) and u(t) follow x_{ref}(t), y_{ref}(t) and u_{ref}(t) not only asymptotically but also during the transient, provided that the adaptive gain is selected sufficiently large. Thus, the control objective is reduced to designing K and C(s) to ensure that the reference LTI system has the desired response D(s).

Remark 4: Notice that if we set C(s)=1, then the [symbol] ₁ adaptive controller degenerates into a CMAC type, which is equivalent to MRAC. In that case

$${‖ C ( s ) \frac{1}{{c}_{o}^{⊤} {H}_{o} ( s )} {c}_{o}^{⊤} ‖}_{{𝔷}_{1}}$$

cannot be finite, since Hₒ(s) is strictly proper. Therefore, from (76) it follows that γ₂→∞, and hence for the control signal in CMAC or MRAC one can not reduce the bound in (74) by increasing the adaptive gain.

### VII. Design of the ₁ Adaptive Controller

We proved that the error between the state and the control signal of the closed-loop system with [symbol] ₁ adaptive controller in (27), (28), (31), (32), (34) (FIG. 11) and the state and the control signal of the closed-loop reference system in (51), (53) (FIG. 12) can be rendered arbitrarily small by choosing large adaptive gain. Therefore, the control objective is reduced to determining K and C(s) to ensure that the reference system in (51), (53) (FIG. 12) has the desired response D(s) from r(t) to y_{ref}(t). Notice that the reference system in FIG. 12 depends upon the unknown parameter θ.

Consider the following signals:
y_{des}(s)=c^{τ}G(s)r(s)=C(s)k_{g}c^{τ}Hₒ(s)r(s), (81)
u_{des}(s)=k_{g}C(s)(1+C(s)θ^{τ}Hₒ(s)−K^{τ}Hₒ(s))r(s). (82)
We note that u_{des}(t) depends on the unknown parameter θ, while y_{des}(t) does not.

Lemma 8: For the LTI system in FIG. 12, subject to (40), the following upper bounds hold:

$$\begin{matrix}{‖ {y}_{ref} - {y}_{des} ‖}_{{𝔷}_{∞}} \leq \frac{λ}{1 - λ} {‖ {c}^{⊤} ‖}_{{𝔷}_{1}} {‖ G ( s ) ‖}_{{𝔷}_{1}} {‖ r ‖}_{{𝔷}_{∞}} , & ( 83 ) \\ {‖ {y}_{ref} - {y}_{des} ‖}_{{𝔷}_{∞}} \leq \frac{1}{1 - λ} {‖ {c}^{⊤} ‖}_{{𝔷}_{1}} {‖ {h}_{3} ‖}_{{𝔷}_{∞}} , & ( 84 ) \\ {‖ {u}_{ref} - {u}_{des} ‖}_{{𝔷}_{∞}} \leq \frac{λ}{1 - λ} {‖ C ( s ) {θ}^{⊤} - {K}^{⊤} ‖}_{{𝔷}_{1}} {‖ G ( s ) ‖}_{{𝔷}_{1}} {‖ r ‖}_{{𝔷}_{∞}} , & ( 85 ) \\ {‖ {u}_{ref} - {u}_{des} ‖}_{{𝔷}_{∞}} \leq \frac{1}{1 - λ} {‖ C ( s ) {θ}^{⊤} - {K}^{⊤} ‖}_{{𝔷}_{1}} {‖ {h}_{3} ‖}_{{𝔷}_{∞}} , & ( 86 )\end{matrix}$$

where λ is defined in (49), and h₃(t) is the inverse Laplace transformation of
H₃(s)=(C(s)−1)C(s)r(s)k_{g}Hₒ(s)θ^{τ}Hₒ(s). (87)
Proof. It follows from (52) and (53) that y_{ref}(s)=c^{τ}(I−\overline{G}(s)θ^{τ})⁻¹G(s)r(s). Following Lemma 6, the condition in (40) ensures the stability of the reference LTI system. Since (I−\overline{G}(s)θ^{τ})⁻¹ is stable, then one can expand it into convergent series and further write

$$\begin{matrix}\begin{matrix}{y}_{ref} ( s ) = {c}^{⊤} ( I + {\sum }_{i = 1}^{∞} {( \overline{G} ( s ) {θ}^{⊤} )}^{i} ) G ( s ) r ( s ) \\ = {y}_{des} ( s ) + {c}^{⊤} ( {\sum }_{i = 1}^{∞} {( \overline{G} ( s ) {θ}^{⊤} )}^{i} ) G ( s ) r ( s ) .\end{matrix} \\ Let {r}_{4} ( s ) = {c}^{⊤} ( {\sum }_{i = 1}^{∞} {( \overline{G} ( s ) {θ}^{⊤} )}^{i} ) G ( s ) r ( s ) . Then & ( 88 ) \\ \begin{matrix}{r}_{4} ( t ) = {y}_{ref} ( t ) - {y}_{des} ( t ) , & ∀ t \geq 0.\end{matrix} & ( 89 )\end{matrix}$$

The relationship in (55) implies that ∥\overline{G}(s)θ^{τ}∥ [symbol] _{₁}≦λ, and it follows from Lemma 2 that

$${‖ {r}_{4} ‖}_{{ℒ}_{∞}} \leq ( {\sum }_{i = 1}^{∞} {λ}^{i} ) {‖ {c}^{⊤} ‖}_{{ℒ}_{1}} {‖ G ‖}_{{ℒ}_{1}} {‖ r ‖}_{{ℒ}_{∞}} = \frac{λ}{1 - λ} {‖ {c}^{⊤} ‖}_{{ℒ}_{1}} {‖ G ‖}_{{ℒ}_{1}} {‖ r ‖}_{{ℒ}_{∞}} . \qquad ( 90 )$$

The relationship in (88) can be equivalently written as

$${y}_{ref} ( s ) = {y}_{des} ( s ) + {c}^{⊤} ( {\sum }_{i = 1}^{∞} {( {\overline{G}}^{′} ( s ) {θ}^{⊤} )}^{i - 1} ) \overline{G} ( s ) {θ}^{⊤} G ( s ) r ( s ) ,$$

which along with (37), (38) and (87) leads to

$$\begin{matrix}{y}_{ref} ( s ) = {y}_{des} ( s ) + {c}^{⊤} ( {\sum }_{i = 1}^{∞} {( {\overline{G}}^{′} ( s ) {θ}^{⊤} )}^{i - 1} ) ( C ( s ) - 1 ) C ( s ) r ( s ) {k}_{g} {H}_{o} ( s ) {θ}^{⊤} {H}_{o} ( s ) \\ = {y}_{des} ( s ) + {c}^{⊤} ( {\sum }_{i = 1}^{∞} {( {\overline{G}}^{′} ( s ) {θ}^{⊤} )}^{i - 1} ) {H}_{3} ( s ) .\end{matrix}$$

Lemma 1 immediately implies that ∥r₄∥ [symbol] _{_{∞}}≦(Σᵢ₌₁^{∞}λⁱ⁻¹)∥c^{τ}∥ [symbol] _{₁}∥h₃∥ [symbol] _{_{∞}}. Comparing u_{des}(s) in (82) to u_{ref}(s) in (51) it follows that u_{des}(s) can be written as u_{des}(s)=k_{g}C(s)r(s)+(C(s)θ^{τ}−K^{τ})x_{des}(s), where x_{des}(s)=C(s)k_{g}Hₒ(s)r(s). Therefore u_{ref}(s)−u_{des}(s)=(C(s)θ^{τ}−K^{τ})(x_{ref}(s)−x_{des}(s)). Hence, it follows from Lemma 1 that ∥u_{ref}−u_{des}∥ [symbol] _{_{∞}}≦∥C(s)θ^{τ}−K^{τ}∥ [symbol] _{₁}∥x_{ref}−x_{des}∥ [symbol] _{_{∞}}. Using the same steps as for ∥y_{ref}−y_{des}∥ [symbol] _{_{∞}}, we have

$${‖ {x}_{ref} - {x}_{des} ‖}_{{ℒ}_{∞}} \leq \frac{λ}{1 - λ} {‖ G ( s ) ‖}_{{ℒ}_{1}} {‖ r ‖}_{{ℒ}_{∞}} , \\ {‖ {x}_{ref} - {x}_{des} ‖}_{{ℒ}_{∞}} \leq \frac{λ}{1 - λ} {‖ {h}_{3} ‖}_{{ℒ}_{∞}} ,$$

which leads to the upper bounds in (85) and (86).

Thus, the problem is reduced to finding a strictly proper stable C(s) to ensure that
(i) λ<1 or ∥h₃∥ [symbol] _{_{∞}} are sufficiently small, (91)
(ii) y_{des}(s)≈D(s)r(s), (92)
where D(s) is the desired LTI system introduced in (12). Then, Theorem 6 and Lemma 8 will imply that the output y(t) of the system in (27) and the [symbol] ₁ adaptive control signal u(t) will follow y_{des}(t) and u_{des}(t) both in transient and steady state with quantifiable bounds, given in (73), (74) and (83)-(86).

Notice that λ<1 is required for stability. From (81)-(86), it follows that for achieving y_{des}(s)≈D(s)r(s) it is desirable to ensure that λ or ∥h₃∥ [symbol] _{_{∞}} are sufficiently small and, in addition, C(s)c^{τ}Hₒ(s)≈D(s). We notice that these requirements are not in conflict with each other. So, using Lemma 2, one can consider the following conservative upper bound
λ=∥\overline{G}(s)∥ [symbol] _{₁}θₘₐₓ=∥Hₒ(s)(C(s)−1∥ [symbol] _{₁}θₘₐₓ≦∥Hₒ(s)∥ [symbol] _{₁}∥C(s)−1∥ [symbol] _{₁}θₘₐₓ. (93)
Thus, minimization of λ can be achieved from two different perspectives: i) fix C(s) and minimize ∥Hₒ(s)∥ [symbol] _{₁}, ii) fix Hₒ(s) and minimize the [symbol] ₁-gain of one of the cascaded systems ∥Hₒ(s)(C(s)−1)∥ [symbol] _{₁}, ∥(C(s)−1)r(s)∥ [symbol] _{₁} or ∥C(s)(C(s)−1)∥ [symbol] _{₁} via the choice of C(s).

i) High-gain design. Set C(s)=D(s). Then minimization of ∥Hₒ(s)∥ [symbol] _{₁} can be achieved via high-gain feedback by choosing K sufficiently large. However, minimized ∥Hₒ(s)∥ [symbol] _{₁} via large K leads to large poles of Hₒ(s), which is typical for high-gain design methods. Since C(s) is a strictly proper system containing the dominant poles of the closed-loop system in k_{g}c^{τ}Hₒ(s)C(s) and k_{g}c^{τ}Hₒ(0)=1, we have k_{g}c^{τ}Hₒ(s)C(s)≈C(s)=D(s). Hence, the system response will be y_{ref}(s)≈D(s)r(s). We note that with large feedback K, the performance of [symbol] ₁ adaptive controller degenerates into a high-gain type. The shortcoming of this design is that the high gain feedback K leads to a reduced phase margin and consequently affects robustness.

ii) Design without linear feedback. As in MRAC, assume that we can select Aₘ to ensure

$$\begin{matrix}{k}_{g} {c}^{⊤} {H}_{o} ( s ) \approx D ( s ) . \\ Let & ( 94 ) \\ C ( s ) = \frac{w}{s + w} . & ( 95 )\end{matrix}$$

Lemma 9: For any single input n-output strictly proper stable system Hₒ(s) the following is true:

$${lim}_{w -> ∞} {‖ ( C ( s ) - 1 ) {H}_{o} ( s ) ‖}_{{ℒ}_{1}} = 0.$$

Proof. It follows from (95) that

$$( C ( s ) - 1 ) {H}_{o} ( s ) = \frac{- s}{s + w} {H}_{o} ( s ) = \frac{- 1}{s + w} s {H}_{o} ( s ) .$$

Since Hₒ(s) is strictly proper and stable, sHₒ(s) is stable and has relative degree ≧0, and hence ∥sHₒ(s)∥ [symbol] _{₁} is finite. Since

$${‖ \frac{- 1}{s + w} ‖}_{{ℒ}_{1}} = \frac{1}{w} ,$$

it follows from (2) that

$${‖ ( C ( s ) - 1 ) {H}_{o} ( s ) ‖}_{{ℒ}_{1}} \leq \frac{1}{w} {‖ s {H}_{o} ( s ) ‖}_{{ℒ}_{1}} ,$$

and the proof is complete.

Lemma 9 states that if one chooses k_{g}c^{τ}Hₒ(s)r(s)≈D(s), then by increasing the bandwidth of the low-pass system C(s), it is possible to render ∥\overline{G}(s)∥ [symbol] _{₁} arbitrarily small. With large ω, the pole −ω due to C(s) is omitted, and Hₒ(s) is the dominant reference system leading to
y_{ref}(s)≈k_{g}c^{τ}Hₒ(s)r(s)≈D(s)r(s).
We note that k_{g}c^{τ}Hₒ(s) is exactly the reference model of the MRAC design. Therefore this approach is equivalent to mimicking MRAC, and, hence, high-gain feedback can be completely avoided.

However, increasing the bandwidth of C(s) is not the only choice for minimizing ∥\overline{G}(s)∥ [symbol] _{₁}. Since C(s) is a low-pass filter, its complementary 1−C(s) is a high-pass filter with its cutoff frequency approximating the bandwidth of C(s). Since both Hₒ(s) and C(s) are strictly proper systems, \overline{G}(s)=Hₒ(s)(C(s)−1) is equivalent to cascading a low-pass system Hₒ(s) with a high-pass system C(s)−1. If one chooses the cut-off frequency of C(s)−1 larger than the bandwidth of Hₒ(s), it ensures that \overline{G}(s) is a “no-pass” system, and hence its [symbol] ₁ gain can be rendered arbitrarily small. This can be achieved via higher order filter design methods. The illustration is given in FIG. 13.

To minimize ∥h₃∥ [symbol] _{_{∞}}, we note that ∥₃∥ [symbol] _{_{∞}} can be upperbounded in two ways:
(i) ∥h₃∥ [symbol] _{_{∞}}∥(C(s)−1)r(s)∥ [symbol] _{₁}∥h₄∥ [symbol] _{_{∞}},

[image]

where h₄(t) is the inverse Laplace transformation of H₄(s)=C(s)k_{g}Hₒ(s)θ^{τ}Hₒ(s), and
(ii) ∥h₃∥ [symbol] _{_{∞}}≦∥(C(s)−1)C(s)∥ [symbol] _{₁}∥h₅∥ [symbol] _{_{∞}},
where h₅(t) is the inverse Laplace transformation of H₅(s)=r(s)k_{g}Hₒ(s)θ^{τ}Hₒ(s).

We note that since r(t) is a bounded signal and C(s), Hₒ(s) are stable proper systems, ∥h₄∥ [symbol] _{_{∞}} and ∥h₅∥ [symbol] _{_{∞}} are finite. Therefore, ∥h₃∥ [symbol] _{_{∞}} can be minimized by minimizing ∥(C(s)−1)r(s)∥ [symbol] _{₁} or ∥(C(s)−1)C(s)∥ [symbol] _{₁}. Following the same arguments as above and assuming that r(t) is in low-frequency range, one can choose the cut-off frequency of C(s)−1 to be larger than the bandwidth of the reference signal r(t) to minimize ∥(C(s)−1)r(s)∥ [symbol] _{₁}. For minimization of ∥C(s)(C(s)−1)∥ [symbol] _{₁} notice that if C(s) is an ideal low-pass filter, then C(s)(C(s)−1)=0 and hence ∥h₃∥ [symbol] _{_{∞}}=0. Since an ideal low-pass filter is not physically implementable, one can minimize ∥C(s)(C(s)−1)∥ [symbol] _{₁} via appropriate choice of C(s).

The above presented approaches ensure that C(s)≈1 in the bandwidth of r(s) and Hₒ(s). Therefore it follows from (81) that y_{des}(s)=C(s)k_{g}c^{τ}Hₒ(s)r(s)≈k_{g}c^{τ}Hₒ(s)r(s), which along with (94) yields y_{des}(s)≈D(s)r(s).

Remark 5: From Corollary 2 and Lemma 8 it follows that the [symbol] ₁ adaptive controller can generate a system response to track (81) and (82) both in transient and steady state if we set the adaptive gain large and minimize λ or ∥h₃∥ [symbol] _{_{∞}}. Notice that u_{des}(t) in (82) depends upon the unknown parameter θ, while y_{des}(t) in (81) does not. This implies that for different values of θ, the [symbol] ₁ adaptive controller will generate different control signals (dependent on θ) to ensure uniform system response (independent of θ). This is natural, since different unknown parameters imply different systems, and to have similar response for different systems the control signals have to be different. Here is the obvious advantage of the [symbol] ₁ adaptive controller in a sense that it controls a partially known system as an LTI feedback controller would have done if the unknown parameters were known. Finally, we note that if the term k_{g}C(s)C(s)θ^{τ}Hₒ(s) is dominated by k_{g}C(s)K^{τ}Hₒ(s), then the controller in (82) turns into a robust one, and consequently the [symbol] ₁ adaptive controller degenerates into robust design.

Remark 6: It follows from (78) that y_{ref}(t), u_{ref}(t) approximate the unknown system's response and the [symbol] ₁ adaptive control signal, if the latter is implemented with large adaptive gain. It follows from (53) that y(t) approximates the response of the LTI system c^{τ}(I−\overline{G}(s)θ^{τ})⁻¹G(s) to r(t), hence its transient performance such as overshoot and settling time can be derived for every value of θ. If we further minimize λ or ∥h₃∥ [symbol] _{_{∞}}, it follows from Lemma 8 that y(t) approximates the response of the LTI system C(s)c^{τ}Hₒ(s). In this case, the [symbol] ₁ adaptive controller leads to uniform transient performance of y(t) independent of the value of the unknown parameter θ. It follows from (80) then that the same is true for the [symbol] ₁ adaptive control signal u(t). For the resulting [symbol] ₁ adaptive control signal one can characterize the transient specifications such as its amplitude and rate change for every θεΩ, using u_{des}(t) for it.

### VIII. Discussion

We use a scalar system to compare the performance of [symbol] ₁ adaptive and a high-gain controllers. Towards that end, let \dot{x}(t)=θx(t)+u(t) where xεIR is the measurable system state, uεIR is the control signal and θεIR is unknown, which belongs to a given compact set [θₘᵢₙ, θₘₐₓ]. Let u(t)=−kx(t)+kr(t), leading to the following closed-loop system:
\dot{x}(t)=(θ−k)x(t)+kr(t).
We need to choose k>θₘₐₓ to guarantee stability. We note that both the steady state error and transient performance depend on the unknown parameter value θ. By further introducing a proportional-integral controller, one can achieve zero steady state error. If one chooses k>>max{θₘₐₓ, θₘᵢₙ}, it leads to high-gain system

$$x ( s ) = \frac{k}{s - ( θ - k )} r ( s ) \approx \frac{k}{s + k} r ( s ) .$$

To apply the [symbol] ₁ adaptive controller, let the desired reference system be

$${H}_{o} ( s ) = \frac{1}{s + 2} .$$

Let u₁=−2x, k_{g}=2, leading to

$$D ( s ) = \frac{2}{s + 2} .$$

Choose C(s) as in (95) with large ωₙ, and set adaptive gain Γ_{c} large. Then it follows from Theorem 6 that

$$\begin{matrix}x ( s ) \approx {x}_{ref} ( s ) = C ( s ) {k}_{g} {H}_{o} ( s ) r ( s ) \approx \frac{{ω}_{n}}{s + {ω}_{n}} \frac{2}{s + 2} \approx \frac{2}{s + 2} & ( 96 ) \\ u ( s ) \approx {u}_{ref} ( s ) = ( - 2 + θ ) {x}_{ref} ( s ) + 2 r ( s ) . & ( 97 )\end{matrix}$$

The relationship in (96) implies that the control objective is met, while the relationship in (97) states that the [symbol] ₁ adaptive controller approximates u_{ref}(t), which cancels the unknown θ.

### IX. Simulations

Consider the same simulation example from Section IV-D. We give now the complete [symbol] ₁ adaptive controller for this system. We set K=0, Γ_{c}=40000, and implement the L₁ adaptive controller following (28), (31), (32) and (34). First, we give analysis of the [symbol] ₁ adaptive controller. It follows from (30) that

$${H}_{o} ( s ) = [ \begin{matrix}\frac{1}{{s}^{2} + 1.4 s + 1} \\ \frac{s}{{s}^{2} + 1.4 s + 1}\end{matrix} ] \qquad ( 98 )$$

and hence

$${y}_{des} ( s ) = C ( s ) {c}^{T} {H}_{o} ( s ) r ( s ) = \frac{1}{{s}^{2} + 1.4 s + 1} C ( s ) r ( s ) . \qquad ( 99 )$$

Next, we check stability of this [symbol] ₁ adaptive controller. It follows from (39) that θₘₐₓ=20, and ∥\overline{G}∥_{L}_{₁} can be calculated numerically. In FIG. 14(a), we plot

$$λ = {‖ \overline{G} ‖}_{{L}_{1}} {θ}_{max} = {‖ \frac{1}{{s}^{2} + 1.4 s + 1} \frac{ω}{s + ω} ‖}_{{ℒ}_{1}} {θ}_{max} \qquad ( 100 )$$

with respect to ω and compare it to 1. We notice that for ω>30, we have λ<1, and the [symbol] ₁ gain requirement for stability is guaranteed. So, we can choose

$$C ( s ) = \frac{160}{s + 160} \qquad ( 101 )$$

to ensure that λ<0.01, which consequently leads to improved performance bounds in (83)-(86). For ω=160, we have λ=∥\overline{G}(s)∥ [symbol] _{₁}θₘₐₓ=0.1725<1, so the [symbol] ₁-gain requirement in (40) is indeed satisfied.

[image]

Next, we compute the bound between y_{ref}(t) and y_{des}(t) in (99). It follows from (87) that

$${‖ {h}_{3} ‖}_{{𝔷}_{∞}} \leq {max}_{θ ∈ Ω} {‖ ( C ( s ) - 1 ) C ( s ) {k}_{g} {H}_{o} ( s ) {θ}^{T} {H}_{o} ( s ) ‖}_{{ℒ}_{1}} {‖ r ‖}_{{ℒ}_{∞}} .$$

For C(s) and Hₒ(s) in (101) and (98), it can be numerically verified that

$${max}_{θ ∈ Ω} {‖ ( C ( s ) - 1 ) C ( s ) {k}_{g} {H}_{o} ( s ) {θ}^{T} {H}_{o} ( s ) ‖}_{{ℒ}_{1}} = 0.0946 , \qquad ( 102 )$$

and it follows from (84) that ∥y_{ref}−y_{des}∥ [symbol] _{_{∞}}≦0.0946∥r∥ [symbol] _{_{∞}}. Therefore, we can state that

$${y}_{ref} ( s ) \approx {y}_{des} ( s ) = C ( s ) {c}^{T} {H}_{o} ( s ) r ( s ) = \frac{1}{{s}^{2} + 1.4 s + 1} \frac{160}{s + 160} r ( s ) .$$

Similarly, it follows from (86) that u_{ref}(t) approximates u_{des}(t), i.e.

$${u}_{ref} ( s ) \approx {u}_{des} ( s ) = 2 \frac{160}{s + 160} ( 1 + \frac{160}{s + 160} {θ}^{⊤} [ \begin{matrix}\frac{1}{{s}^{2} + 1.4 s + 1} \\ \frac{s}{{s}^{2} + 1.4 s + 1}\end{matrix} ] ) r ( s ) .$$

With large adaptive gain, it follows from Theorem 6 that y(t)≈y_{ref}(t), u(t)≈u_{ref}(t), ∀t≧0, and hence

$$y ( s ) \approx \frac{1}{{s}^{2} + 1.4 s + 1} \frac{160}{s + 160} r ( s ) \approx \frac{1}{{s}^{2} + 1.4 s + 1} r ( s )$$

$$u ( s ) \approx 2 \frac{160}{s + 160} ( 1 + \frac{160}{s + 160} {θ}^{⊤} [ \begin{matrix}\frac{1}{{s}^{2} + 1.4 s + 1} \\ \frac{s}{{s}^{2} + 1.4 s + 1}\end{matrix} ] ) r ( s ) \approx 2 r ( s ) + {θ}^{⊤} [ \begin{matrix}\frac{1}{{s}^{2} + 1.4 s + 1} \\ \frac{s}{{s}^{2} + 1.4 s + 1}\end{matrix} ] r ( s ) ,$$

if one just considers the dominant poles. The simulation results of the [symbol] ₁ adaptive controller are shown in FIGS. 15(a)-15(b) for reference inputs r=25, 100, 400, respectively. We note that it leads to scaled control input and system response for scaled reference input, as compared to MRAC in FIGS. 8(a)-10(b). FIG. 16(a)-16(b) show the system response and control signal for reference input r(t)=100 cos(0.2t), without any retuning of the controller.

[image]

[image]

Next, we consider a higher order filter with low adaptive gain Γ_{c}=400,

$$C ( s ) = \frac{3 {w}^{2} s + {w}^{3}}{{( s + w )}^{3}} .$$

In FIG. 14(a), we plot

$$λ = {‖ \overline{G} ‖}_{{L}_{1}} {θ}_{max} = {‖ \frac{1}{{s}^{2} + 1.4 s + 1} \frac{3 {w}^{2} s + {w}^{3}}{{( s + w )}^{3}} ‖}_{{ℒ}_{1}} {θ}_{max} \qquad ( 103 )$$

with respect to ω and compare it to 1. We notice that when ω>25, we have λ<1 and the [symbol] ₁-gain requirement in (40) is satisfied. Letting ω=50 leads to λ=0.3984, and therefore ∥y_{ref}−y_{des}∥ [symbol] _{_{∞}}≦0.0721∥r∥ [symbol] _{_{∞}}. Following similar arguments above

$$y ( s ) \approx {y}_{des} ( s ) = \frac{1}{{s}^{2} + 1.4 s + 1} \frac{3 {w}^{2} s + {w}^{3}}{{( s + w )}^{3}} r ( s ) \approx \frac{1}{{s}^{2} + 1.4 s + 1} r ( s ) , \qquad ( 104 )$$

if one just considers the dominant poles. The simulation results of the [symbol] ₁ adaptive controller are shown in FIGS. 11(a)-11(b), for reference inputs r=25, 100, 400, respectively. We note that it again leads to scaled control input and system response for scaled reference input, as compared to MRAC in FIGS. 8(a)-10(b). In addition, we notice that this performance is achieved by a much smaller adaptive gain as compared to the design with the first order C(s). FIG. 18(a)-18(b) show the system response and control signal for reference input r(t)=100 cos(0.2t), without any retuning of the controller.

[image]

Remark 7: The simulations pointed out that with higher order filter C(s) one could use relatively small adaptive gain. While a rigorous relationship between the choice of adaptive gain and the order of filter cannot be derived, an insight into this can be gained from the following analysis. It follows from (27), (28) and (34) that
x(s)=G(s)r(s)+Hₒ(s)θ^{τ}x(s)+Hₒ(s)C(s)\overline{r}(s), (105)
while the companion model in (36) can be rewritten as
\hat{x}(s)=G(s)r(s)+Hₒ(s)(C(s)−1)\overline{r}(s).

We note that \overline{r}(t) is divided into two parts. Its low-frequency component C(s)\overline{r}(s) is what the system in (105) gets, while the complementary high-frequency component (C(s)−1)\overline{r}(s) goes into the companion model. If the bandwidth of C(s) is large, then it can suppress only the high frequencies in \overline{r}(t), which appear only in the presence of large adaptive gain. A properly designed higher order C(s) can be more effective to serve the purpose of filtering with reduced tailing effects, and, hence can generate similar λ with smaller bandwidth. This further implies that similar performance can be achieved with smaller adaptive gain.

Note the following references referred to in the above discussion: [1] is P. Ioannou and J. Sun, Robust Adaptive Control (Prentice Hall, 1996); [2] is H. K. Khalil, Nonlinear Systems (Prentice Hall, Englewood Cliff, N.J., 2002); [3] is J.-J. E. Slotine and W. Li, Applied Nonlinear Control (Prentice Hall, Englewood Cliffs, N.J., 1991).

While the invention has been described in terms of preferred embodiments, those skilled in the art will recognize that the invention can be practiced with modification within the spirit and scope of the appended claims.

1. A low-pass adaptive/neural controller for a dynamic system, comprising:
a reference input for the dynamic system, the dynamic system being described by a dynamic model subject to time-varying unknown parameters and an unknown time-varying disturbance, there being a measured output of the dynamic system;
a companion model, described by the dynamic model, adaptive estimates being substituted in the dynamic model for the time-varying unknown parameters and the unknown time-varying disturbance, there being a computed output for the companion model; and
means for generating a control signal to be applied to the dynamic system and the companion model so that the measured output tracks the reference input, said generating means having a low-pass filter to attenuate high frequency components in the control signal;
wherein said low-pass filter is a stable transfer function and is applied by said generating means so that both the control signal and a tracking error difference between the measured output and the reference input achieve a target stability and desired performance asymptotically within a transient period.

2. The controller of claim 1, wherein an adaptive gain applied by said generating means is made very large in order to regulate the tracking error asymptotically within desired bounds during the transient period.

3. The controller of claim 1, wherein an error signal difference between said measured output and said computed output is used to generate the adaptive estimates.

4. The controller of claim 1, wherein the control signal is generated by applying said stable transfer function to a feedback signal derived from the reference input, said measured output and the adaptive estimates.

5. The controller of claim 4, wherein the low-pass filter is applied to only a part of the feedback signal.

6. The controller of claim 1, wherein the low-pass filter cascaded with the desired reference system has L₁ gain, the L₁ gain being less than an inverse of an upper bound of a norm of the unknown parameters.

7. A method for adaptively controlling a dynamic system, comprising:
defining an error signal between a measured output of the dynamic system and a computed output of a companion model, the dynamic system being described by a dynamic model subject to time-varying unknown parameters and an unknown time-varying disturbance, adaptive estimates for the unknown parameters and the unknown disturbance being substituted in the companion model to produce the computed output;
generating a control signal with a low-pass filter to attenuate high frequency components in the control signal; and
applying the control signal to the dynamic system and the companion model so that the measured output tracks a reference input,
wherein said low-pass filter is a stable transfer function and is applied by said generating means so that both the control signal and a tracking error difference between the measured output and the reference input achieve a target stability and desired performance asymptotically within a transient period.

8. The method of claim 7, wherein an adaptive gain of the control signal is made very large in order to regulate the tracking error asymptotically within desired bounds during the transient period.

9. The method of claim 7, wherein an error signal difference between said measured output and said computed output is used to generate the adaptive estimates.

10. The method of claim 7, wherein the control signal is generated by applying said stable transfer function to a feedback signal derived from the reference input, said measured output and the adaptive estimates.

11. The method of claim 10, wherein the low-pass filter is applied to only a part of the feedback signal.

12. The method of claim 7, wherein an adaptive gain of the control signal is less than an inverse of an upper bound of a norm of the unknown parameters.
